(19) United States
(12) Patent Application Publication
(10) Pub. No.: US 2003/0232649 A1
(43) Pub. Date: Dec. 18, 2003

(54) Gaming system and method

(76) Inventors: Alexander C.M. Gizis, Philadelphia, PA (US); Bhana S. Grover, Philadelphia, PA (US)

Correspondence Address: Kirk D. Houser, Eckert Seamans Cherin & Mellott, LLC, 44th Floor, 600 Grant St., Pittsburgh, PA, 15219, US

(21) Appl. No.: 10/174,517

(22) Filed: Jun. 18, 2002

(51) Int. Cl. G06F 17/00; G06F 19/00

(52) U.S. Cl. 463/40

(57) ABSTRACT

A gaming system includes a plurality of mobile gaming units, such as robots, having a first communication link for at least a plurality of messages and a video output, motors and wheels for moving the robot responsive to an input, a processor receiving at least some of the messages and providing the input, and a video camera providing the video output, which includes a representation of another robot and/or at least a portion of a gaming environment. The gaming system also includes controllers for the robots. The controllers include a second communication link in communication with at least one of the first communication links for at least the messages and the video output, a display displaying the video output from the second communication link, an input device having an output, and a processor receiving the output of the input device and providing at least some of the messages.

### BACKGROUND OF THE INVENTION

1. Field of the Invention

The invention relates to gaming systems and, more particularly, to gaming systems including mobile gaming units, controllers and video cameras. The invention also relates to gaming methods and, more particularly, to gaming methods employing mobile gaming units, controllers and video cameras.

2. Background Information

U.S. Pat. No. 4,938,483 discloses a multi-vehicle interactive combat type game employing controllers each of which communicates with one or more vehicles (e.g., tanks).

U.S. Pat. No. 5,647,747 discloses a plurality of electro-mechanical robots in human form designed to resemble hockey players. Video cameras record training sessions between the students and the robots. U.S. Pat. No. 5,647,747 claims a video camera coupled to an armature of a robot for capturing video images of interactions between the robot and activity on the hockey rink.

U.S. Pat. No. 6,220,865 discloses mechanized electro-mechanical robots, preferably in human form and preferably outfitted to resemble hockey players. The robots can include a video recorder, which can be mounted in the helmet to record practice sessions from the perspective of the robot.

U.S. Pat. No. 6,302,796 discloses a shooting game including a plurality of player sets, each of which includes a toy light projector or light gun configured as a futuristic “ray” gun, and at least one player-carried light detector which includes at least one sensor.

U.S. Pat. No. 6,261,180 discloses a portable, programmable, interactive toy for a shooting game played by radiating and appropriately detecting infrared light (or other radiated energy).

U.S. Pat. No. 6,254,486 discloses a system including two components, each of which is user controlled. Each component includes a controller and a controlled unit, such as a robot.

U.S. Pat. No. 6,248,019 discloses an amusement apparatus including a plurality of floats on a swimming pool and a number of targets mounted on the swimming pool surround. The floats and the targets are all in radio communication with a base station.

U.S. Pat. No. 5,127,658 discloses a remotely-controlled vehicular toy having a light beam emitter or gun, which emits a directed light beam, and a plurality of light beam detectors. Each of the toys is interoperative with an associated remote controller.

U.S. Pat. No. 5,904,621 discloses a hand-held electronic toy gun and target apparatus facilitating a game of tag using infrared light communications between a plurality of players.

U.S. Pat. No. 6,071,166 discloses toy objects, such as action figures, robots, vehicles and creatures, for playing a shooting game controlled by one or more human players.

U.S. Pat. No. 6,328,651 discloses a target-shooting toy, which optically projects an image of a target, which can be aimed at and hit.

U.S. Pat. No. 6,195,626 discloses systems and methods for enhancing the realism of the computer-controlled artificial intelligence (AI) units of a multi-unit simulator for competitive gaming and other applications, such as real-time simulation of skill-based activities such as air-to-air combat.

U.S. Pat. No. 6,166,744 discloses a system for combining virtual images with images of the real world.

U.S. Pat. Nos. 6,141,060 and 5,917,553 disclose a method and apparatus for replacing a target image with a second image, overlaying the target image, or highlighting the target image.

U.S. Pat. No. 6,317,128 discloses in the Background of the Invention section variably-transparent (transparent/semi-transparent) windows, menus or other objects such that the user can “see through” to underlying layers.

U.S. Pat. No. 6,031,545 discloses a vision system for combining images of a real scene with computer generated imagery where the computer generated imagery is particular to the position and pointing attitude of the device.

There is room for improvement in gaming systems and methods.

### SUMMARY OF THE INVENTION

This need and others is met by the present invention, which provides a gaming system and method for a gaming environment. A plurality of mobile gaming units and a plurality of controllers for the mobile gaming units are provided. Video data is received (e.g., by a video camera) at one or more of the mobile gaming units. The video data represents at least one of: (a) another one of the mobile gaming units, and (b) at least a portion of the gaming environment. The video data is sent from the mobile gaming unit to a corresponding one of the controllers. The video data is received at the corresponding controller and is responsively displayed (e.g., at a video display). This allows the user or player to see what the corresponding mobile gaming unit “sees” through the video camera. Hence, the user or player may control the mobile gaming unit by watching the video display of the corresponding controller.

As one aspect of the invention, a gaming system for a gaming environment comprises: a plurality of mobile gaming units, each of the mobile gaming units comprising a first communication link for at least a plurality of messages and a video output, means for moving the mobile gaming unit responsive to an input, a processor receiving at least some of the messages and providing the input of the means for moving, a video camera providing the video output including a representation of at least one of: (a) another one of the mobile gaming units, and (b) at least a portion of the gaming environment, and a power source; and a plurality of controllers for the mobile gaming units, each of the controllers comprising a second communication link in communication with at least one of the first communication links for at least the messages and the video output, a display displaying the video output from the second communication link, an input device having an output, and a processor receiving the output of the input device and providing at least some of the messages.

The first communication link may comprise a first radio frequency transmitter having an input, a first radio frequency receiver having an output, and a second radio frequency transmitter transmitting the video output. The second communication link may comprise a second radio frequency receiver tuned to at least one of the first radio frequency transmitters, the second radio frequency receiver having an output, a third radio frequency transmitter tuned to at least one of the first radio frequency receivers, the third radio frequency transmitter having an input, and a third radio frequency receiver tuned to one of the second radio frequency transmitters, the third radio frequency receiver receiving the video output. The processor of the mobile gaming units may provide the input of the first radio frequency transmitter, and may receive the output of the first radio frequency receiver. The display may display the video output from the third radio frequency receiver. The processor of the controller may receive the output of the second radio frequency receiver, and may provide the input of the third radio frequency transmitter.

The video output of the video camera may include a representation of at least one of another one of the mobile gaming units and the gaming environment. The video output of the video camera may include a representation of the gaming environment.

As another aspect of the invention, a gaming method for a gaming environment comprises: employing a plurality of mobile gaming units; employing a plurality of controllers to control corresponding ones of the mobile gaming units; receiving video data at some of the mobile gaming units, the video data representing at least one of: (a) another one of the mobile gaming units, and (b) at least a portion of the gaming environment; sending the video data from the some of the mobile gaming units to some of the controllers; and receiving the video data at the some of the controllers and responsively displaying the video data.

The method may further comprise employing first and second mobile gaming units as the mobile gaming units; employing first and second controllers as the controllers; sending a first message from the first controller; receiving the first message at the first mobile gaming unit and responsively outputting a wireless signal; receiving the wireless signal at the second mobile gaming unit and responsively sending a second message, which confirms receipt of the wireless signal; receiving the second message at the second controller and responsively sending a third message, which confirms receipt of the second message; and receiving the third message at the first controller and responsively displaying a representation with the second mobile gaming unit.

The second mobile gaming unit may be disabled responsive to receiving the second message at the second controller. The method may further comprise sending a fourth message responsive the disabling the second mobile gaming unit; and receiving the fourth message at the first controller and responsively displaying a fifth message.

A video camera may be employed to receive the video data at the one of the mobile gaming units; the video display may be employed to display the video data; and the video display may be employed to determine a position of the one of the mobile gaming units in the gaming environment.

A barrier may be employed with the gaming environment. The video display may be employed to determine a position of the barrier in the gaming environment.

Computer-generated graphics may be provided at one of the controllers. The video data may be displayed in combination with the computer-generated graphics.

A representation of damage to one of the mobile gaming units may be employed as the computer-generated graphics. A representation of a windshield of one of the mobile gaming units may be employed; and a representation of damage to the windshield may be displayed.

As another aspect of the invention, a gaming system for a gaming environment comprises: a plurality of mobile gaming units; and a plurality of controllers to control corresponding ones of the mobile gaming units, with at least some of the mobile gaming units comprising: means for receiving video data representing at least one of: (a) another one of the mobile gaming units, and (b) at least a portion of the gaming environment, and means for sending the video data to a corresponding one of the controllers; and with at least some of the controllers comprising: means for receiving the video data from a corresponding one of the mobile gaming units, and means for responsively displaying the received video data.

As another aspect of the invention, a gaming method for a gaming environment comprises: employing at least first and second mobile gaming units; employing at least first and second controllers for the mobile gaming units; sending a first message from the first controller; receiving the first message at the first mobile gaming unit and responsively outputting a wireless signal; receiving the wireless signal at the second mobile gaming unit and responsively sending a second message, which confirms receipt of the wireless signal; receiving the second message at the second controller and responsively sending a third message, which confirms receipt of the second message; and receiving the third message at the first controller and responsively displaying a representation with the second mobile gaming unit.

The video data may be received at the first mobile gaming unit; the video data may be sent from the first mobile gaming unit to the first controller; and the video data may be received at the first controller, which responsively displays the video data.

### BRIEF DESCRIPTION OF THE DRAWINGS

A full understanding of the invention can be gained from the following description of the preferred embodiments when read in conjunction with the accompanying drawings in which:

FIG. 1 is a block diagram of a gaming system in accordance with the present invention.

FIG. 2 is a block diagram of a gaming system in accordance with another embodiment of the invention.

FIG. 3 is a flowchart of a gaming method in accordance with another embodiment of the invention.

FIG. 4 is a block diagram in schematic form of the mobile gaming unit of FIG. 2.

FIG. 5 is a block diagram in schematic form of the controller of FIG. 2.

FIG. 6 is a flowchart of firmware executed by the processor of FIG. 4.

FIG. 7 is a block diagram of the game software for the controllers of FIG. 2.

FIGS. 8A-8B are flowcharts of firmware executed by the mobile gaming units and software executed by the controllers of FIG. 2 for a game in accordance with another embodiment of the invention.

FIG. 9 is a representation of a video display of a gaming environment as captured by the video camera of the mobile gaming unit and displayed on the video display of the corresponding controller of FIG. 2.

FIGS. 10-16 are representations of video displays of gaming environments and/or other mobile gaming units as captured by the video camera of a mobile gaming unit and displayed along with computer-generated graphics on the video display of the corresponding controller of FIG. 2.

FIG. 17 is a block diagram of a controller in accordance with another embodiment of the invention.

FIGS. 18A-18C are block diagrams of wireless transmitters and receivers in accordance with other embodiments of the invention.

FIGS. 19-21 are block diagrams of mobile gaming units in accordance with other embodiments of the invention.

FIG. 22 is a block diagram of a gaming system in accordance with another embodiment of the invention.

### DESCRIPTION OF THE PREFERRED EMBODIMENTS

As employed herein, the terms “game” and “gaming” refer to activities engaged in for amusement, as a pastime, or to make time pass agreeably.

As employed herein, the term “mobile gaming unit” shall expressly include, but not be limited to, any gaming robot, gaming telerobot, toy vehicle, toy tank, toy boat, toy submarine, toy airplane, toy airship, toy aircraft, and toy helicopter.

As employed herein, the term “video camera” shall expressly include, but not be limited to, any device or camera having a video output, and/or any device or camera providing a picture or an image of an object or an environment for recording, displaying and/or communicating.

As employed herein, the term “communication network” shall expressly include, but not be limited to, any local area network (LAN), wide area network (WAN), intranet, extranet, global communication network, wireless (e.g., radio frequency; infrared; IEEE 802.11; Wi-Fi; Bluetooth™; cellular) communication system or network, and the Internet.

As employed herein, the term “communication link” shall expressly include, but not be limited to, any point-to-point communication channel or channels, and any communication network.

As employed herein, the term “gaming environment” shall expressly include, but not be limited to, the circumstances, objects, or conditions surrounding one or more mobile gaming units (e.g., another mobile gaming unit; a barrier; a sensor object; a goal); and/or any environment for one or more mobile gaming units (e.g. a surface; a liquid; an environment above or below a surface; a local gaming environment; a remote gaming environment; a gaming arena).

Referring to FIG. 1, a gaming system 2 for a gaming environment 4 includes a plurality of mobile gaming units (MGUs) 6,8, and a plurality of controllers 10,12 for such mobile gaming units. The mobile gaming units, such as 6, include a suitable circuit, such as video camera (VC) 14, for receiving video data, which represents one or both of: (a) another one of the mobile gaming units, such as 8, and (b) at least a portion of the gaming environment 4. The mobile gaming units, such as 6, also include a suitable circuit, such as transmitter (TX) 16, for sending the video data to a corresponding one of the controllers, such as 10. The controllers, such as 10, include a suitable circuit, such as receiver (RX) 18, for receiving the video data, and a suitable circuit, such as display 20, for responsively displaying the received video data.

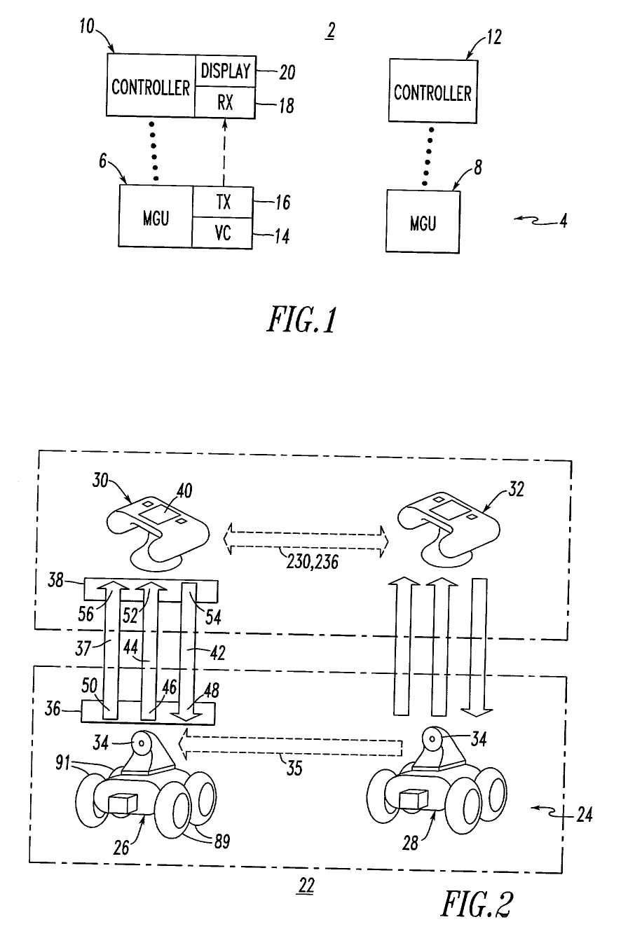

FIG. 2 shows another gaming system 22 for a gaming environment 24. The gaming system 22 includes a plurality of mobile gaming units, such as robots 26,28, and a plurality of controllers 30,32 for such robots. The robots, such as 26, include a video camera (VC) 34, for receiving video data, which represents one or both of: (a) another one of the robots, such as 28, and (b) at least a portion of the gaming environment 24. The robots, such as 26, also include a suitable circuit, such as a communication link or transceiver 36, for sending video data 37 to a corresponding one of the controllers, such as 30. The controllers, such as 30, include a suitable circuit, such as a communication link or transceiver 38, for receiving the video data 37, and a suitable circuit, such as display 40, for responsively displaying the received video data.

In addition to the video data 37, the communication links or transceivers 36,38 also communicate a plurality of command messages 42 from the controller 30 to the robot 26, and a plurality of status messages 44 from the robot 26 to the controller 30.

The first communication link 36 includes a first radio frequency transmitter 46, a first radio frequency receiver 48, and a second radio frequency transmitter 50, which transmits the video data 37. The second communication link 38 includes a second radio frequency receiver 52 tuned to at least one of the first radio frequency transmitters 46, a third radio frequency transmitter 54 tuned to at least one of the first radio frequency receivers 48, and a third radio frequency receiver 56 tuned to one of the second radio frequency transmitters 50. The third radio frequency receiver 56 receives the video data 37. Although point-to-point communication links 36,38 are shown, the invention is applicable to any suitable communication link. For example, a suitable communication network (e.g., 440 of FIG. 17) may be employed. Also, the communication links 36,38 may employ one or more transceivers having one or more channels for command, status and video information.

The input of the first radio frequency transmitter 46 of the robot 26 includes robot sensor data for at least one of the controllers 30,32. The output of the first radio frequency receiver 48 of the robot 26 includes commands from one of the controllers, such as 30.

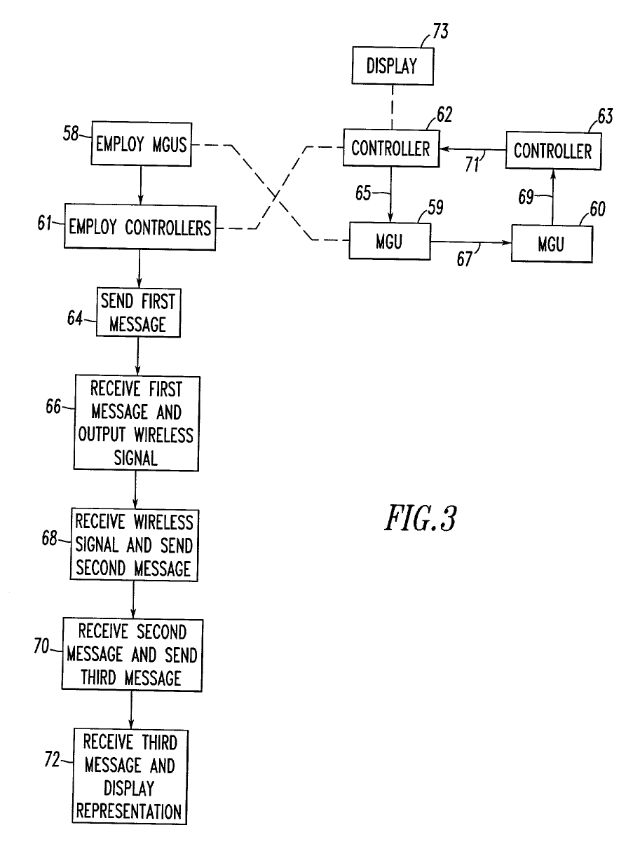

Referring to FIG. 3, a gaming method for a gaming environment includes employing, at 58, at least first and second mobile gaming units (MGUs) 59,60; employing, at 61, at least first and second controllers 62,63 for the respective mobile gaming units 59,60; sending, at 64, a first message 65 from the first controller 62; receiving, at 66, the first message 65 at the first mobile gaming unit 59 and responsively outputting a wireless signal 67, which mimics a weapon; receiving, at 68, the wireless signal 67 at the second mobile gaming unit 60 and responsively sending a second message 69, which confirms receipt of the wireless signal 67; receiving, at 70, the second message 69 at the second controller 63 and responsively sending a third message 71, which confirms receipt of the second message 69; and receiving, at 72, the third message 71 at the first controller 62 and responsively displaying a representation 73 of the weapon interacting with the second mobile gaming unit 60.

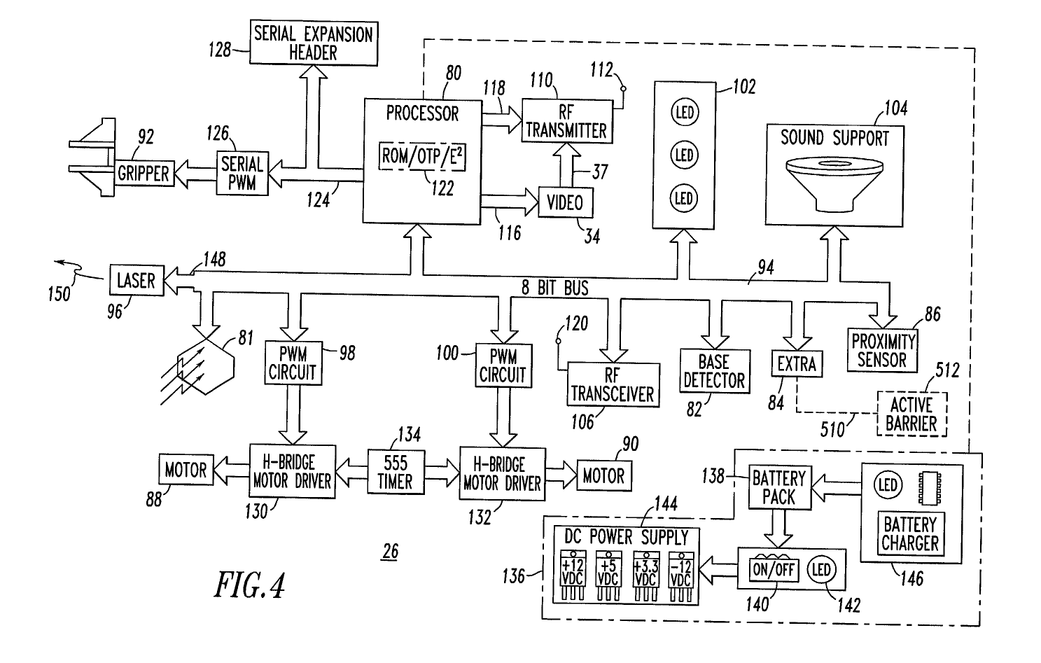

FIG. 4 shows the robot 26 of FIG. 2. The robot 26 includes a suitable processor 80 (e.g., a microcomputer), which monitors or controls one or more sensors 81,82,84,86, suitable motors 88,90 (e.g., electric) for moving the robot and/or servos 92 for gripping objects (not shown) by the robot. The processor 80 includes a conventional bus 94 (e.g., 8-bit) for control and/or monitoring of various devices thereon. The bus 94 provides inputs from the sensors 81,82,84,86, outputs to one or more of a laser 96, PWM circuits 98,100, LEDs 102 and sound support 104, and inputs/outputs to/from a two-way wireless (e.g., RF) transceiver 106.

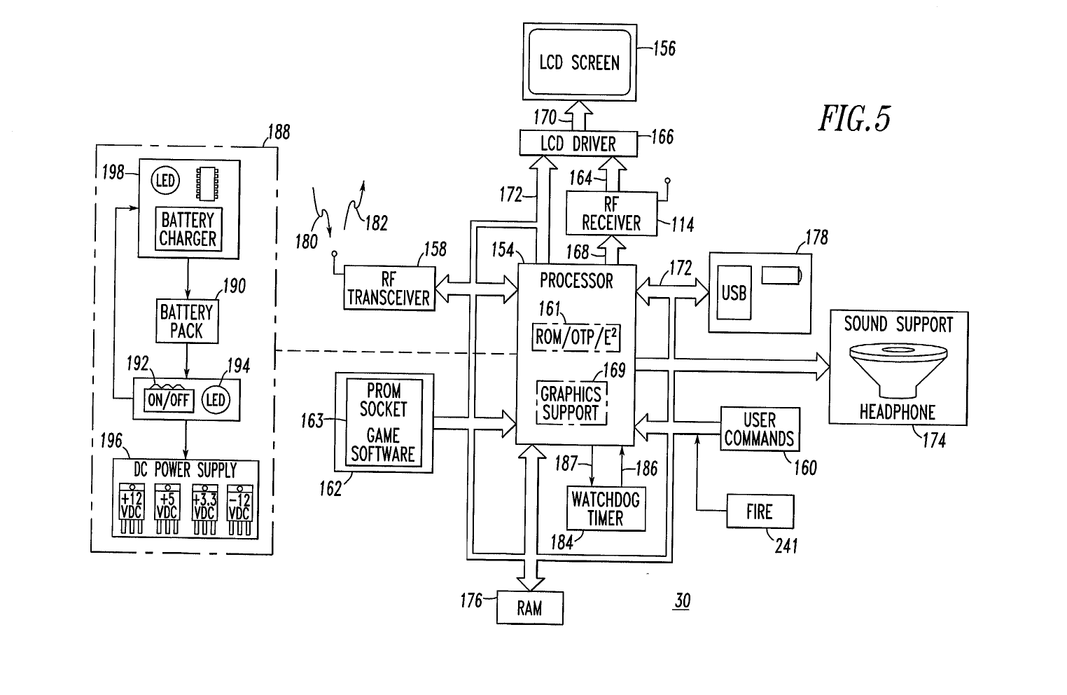

The video camera 34 outputs the video data 37 to a wireless (e.g., RF) transmitter 110 having an antenna 112. In turn, the transmit video data is received by the wireless (e.g., RF) receiver 114 of the controller 30 of FIG. 5. One or more output ports 116,118 of the processor 80 may be employed to control the video camera 34 and the RF transmitter 110, respectively. The transceiver 106 has an antenna 120 and receives commands from and sends sensor data to a controller, such as 30 of FIG. 2. In this manner, the processor 80 may provide the input of the first radio frequency transmitter 46 of FIG. 2, and may receive the output of the first radio frequency receiver 48 of FIG. 2.

For example, the processor 80 sends control signals directly to the video camera 34 and the RF transmitter 110. These may include, for example, turning on and off the video camera 34 through the output port 116, and turning on and off and controlling the channel employed for broadcast by the RF transmitter 110 through the output port 118. As another example, the robot 26 may, in any given area, broadcast the video data 37 on a unique channel, in order to ensure that the robot 26 does not interfere with another robot's video signals as output by another RF transmitter 110. Preferably, the video camera 34 is directly connected to the RF transmitter 110, in order that when both are activated, the video data 37 streams directly from the camera 34 to the transmitter 110 without passing through the processor 80 or the bus 94.

The processor 80 preferably has local memory 122 (e.g., ROM, RAM, EEPROM, one time programmable memory) and a serial output port 124 to a serial PWM device 126 and a serial expansion header 128. The serial PWM device 126 advantageously controls the servos, such as the gripper 92. The serial expansion header 128 may interface with other devices (not shown), such as a PC. The memory 122 contains an embedded firmware program, which suitably controls the robot 26.

The PWM circuits 98,100 interface H-bridge motor drivers 130,132, which control left and right side motors 88,90 for driving left and right side wheels 89,91 (as shown in FIG. 2), respectively, in order to maneuver the robot 26. A suitable timer 134 provides a suitable time base or clock for the motor drivers 130,132.

Power for the processor 80 and related circuits is provided by a suitable power source 136. The exemplary power source 136 includes a battery pack 138, an on/off switch 140, an indicator LED 142, and a suitable set of one or more DC/DC regulators 144. Preferably, a battery charger 146 may be employed to recharge the battery pack 138.

The laser 96 of the processor 80 forms a wireless output having an input 148 from the bus 94 and a responsive wireless signal, such as a laser beam 150, which mimics a “weapon”. The processor 80 turns the laser 96 on and off over the bus 94 to simulate the firing of the weapon. In a related manner, the robot 26 includes one or more sensors 81 (e.g., front; back; left side; right side), which detect the laser beam of a different robot, such as 28 of FIG. 2. The sensors 81 sense at least one of the wireless signals 150 of another one of the robots and output the corresponding sensor data to the bus 94 for the processor 80.

The other sensors 82,84,86 may be employed to detect other active or passive objects (not shown). For example, the base detector 82 may detect a suitable signal (not shown) from a transmitter (not shown) associated with a “home base” for a game. The extra sensor 84 may detect an active signal 510 of an object such as another robot or an active “barrier” 512. The proximity sensor 86 may detect a fixed object (not shown), such as a “barrier” for a game.

Various commands are received through the RF transceiver 106 from the corresponding controller 30 of FIG. 2. For example, one command may be employed by the processor 80 to control the PWM circuits 98,100 and, thus, the respective motors 88,90 (e.g., on or off, forward or reverse, minimum or maximum speed), and another command may be employed by the processor 80 to control (e.g., turn on or off) the laser 96.

FIG. 5 shows the controller 30 of FIG. 2. Although a handheld controller is shown, any suitable electronic, programmable device may be employed, such as, for example, the personal computer (PC) 152 of FIG. 17. The controller 30 includes a suitable processor 154 (e.g., a microcomputer), the RF receiver 114 for video data, a suitable display, such as LCD screen 156, for display of video and graphics, an RF transceiver 158 for commands and data, and a suitable input device 160 (e.g., user controls, such as plural pushbuttons; a mouse; a track pad; a game pad; and/or a joystick) for user entry of commands. The processor 154 preferably has local memory 161 (e.g., ROM, EEPROM, one time programmable (OTP) memory) for fixed gaming functions, and is capable of running software from an external PROM socket 162, which controls the rules of the game. In this manner, a PROM, such as 163, may store a particular game, with the PROM socket 162 receiving the PROM and, thus, the particular game. In the exemplary controller 30, the video stream 164 goes directly from the RF video receiver 114 to an LCD driver 166. The processor 154 has a port output 168, which controls whether the receiver 114 is on, and which selects the corresponding channel for the video stream 164.

The processor 154 may include graphics support firmware 169 to create graphics (e.g., vector; bit-mapped), which are superimposed on the video output 170 of the LCD driver 166. These graphics are directly output by the processor 154 to the LCD driver 166 via conventional bus 172 (e.g., 8-bit). The LCD driver 166 then merges the graphics over the video stream 164. This approach allows the processor 154 to be a relatively inexpensive processor, which does not need to handle real-time video. The RF transceiver 158 delivers the sensor data and game data from the robot 26 directly to the controller processor 154 through the bus 172.

The processor bus 172 provides for control and/or monitoring of various devices thereon. The bus 172 provides inputs from the PROM socket 162 and the input device 160, outputs to the sound support 174 (e.g., speaker and/or headphones), and inputs/outputs to/from the two-way wireless (e.g., RF) transceiver 158, RAM 176 and USB (Universal Serial Bus) device 178.

The processor 154 receives the output of the input device 160, sensor data messages 180 from the robots, such as 26, as received by the transceiver 158, and provides at least some of the command messages 182 to such robot as output by such transceiver.

The LCD screen 156 may display the output video stream 164 from the receiver 114 and from the transmitter 110 of the robot 26 of FIG. 4. In this manner, the video data 37 is sent from the robot 26, is received by the controller 30, and is responsively displayed on the LCD screen 156.

A watchdog timer 184 is preferably employed to reset the processor 154 through a reset line 186 in the event of a hardware and/or software problem upon loss of a repetitive signal on output port 187 from the processor 154.

Power for the processor 154 and related circuits is provided by a suitable power source 188. The exemplary power source 188 includes a battery pack 190, an on/off switch 192, an indicator LED 194, and a suitable set of one or more DC/DC regulators 196. Preferably, a battery charger 198 may be employed to recharge the battery pack 190.

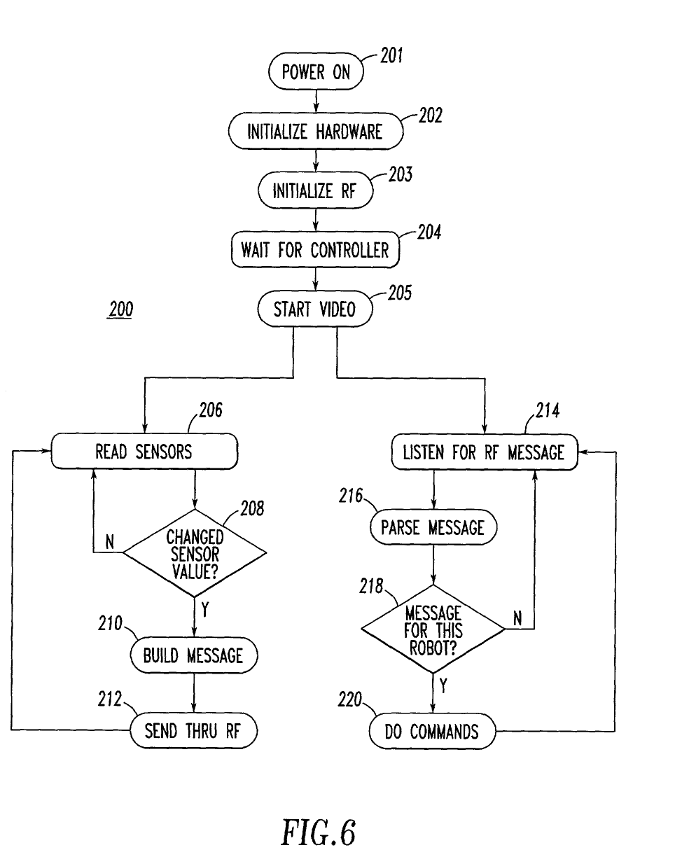

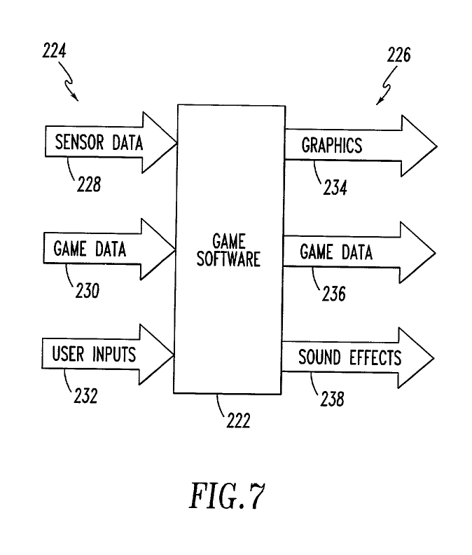

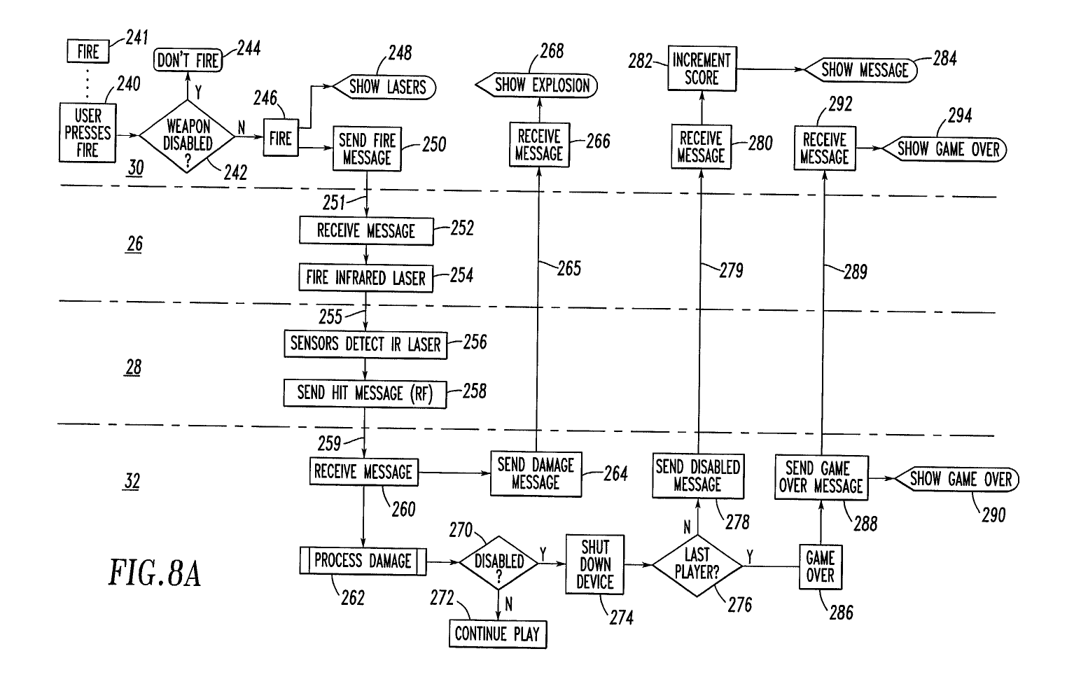

FIG. 6 illustrates the flow of the firmware in the local memory 122 of the robot 26 of FIG. 4. Following power on (e.g., through on/off switch 140), at 201, the processor 80 initializes the robot hardware, at 202, and the RF transmitter 110 and RF transceiver 106, at 203. Next, at 204, the processor 80 waits for a suitable command message from the controller processor 154 of FIG. 5. After that is received, the video camera 34 and RF transmitter 110 are enabled through the output ports 116 and 118, respectively, at 205.

Each of the robots, such as 26, has a unique serial number stored in the permanent memory 122 thereof (e.g., done at manufacturing time). This serial number is employed in the wireless messages 180,182 of FIG. 5 as the address in each message, in order to identify which robot the message is coming from or going to. Internally, the robot processor 80 is executing two tasks in parallel (e.g., multi-tasked; time-division-multiplexed). The first task (steps 206,208,210,212) continuously polls the robot's sensors (e.g., 81,82,84,86) and, if data is received, transmits the sensor data messages 180 back to the corresponding controller, such as 30, through the RF transceivers 106 (FIG. 4) and 158 (FIG. 5). The second task (steps 214,216,218,220) waits for the command messages 182 to arrive from the RF transceiver 106. When such command messages arrive, the robot processor 80 examines them to determine if the command message was, in fact, intended for this robot (based on the address in the message's header). If the command message was intended for this robot, then the robot processor 80 uses the data from the message to set appropriate values for the robot motors 88,90 (through the PWM circuits 98,100) and other devices (e.g., the laser 96, the gripper 92).

In the first task, at 206, the various robot sensors are read. Next, at 208, it is determined if there was a changed value in any of the sensor data. If not, then step 206 is repeated. On the other hand, if there was a changed value in any of the sensor data, then a suitable sensor data message 180 is built at 210. That sensor data message is sent to the corresponding controller, such as 30, through the RF transceiver 106, at 212, after which step 206 is repeated.

For the second task, at 214, the processor 80 listens and waits for one of the RF command messages 182. Next, at 216, the received command message is parsed to obtain the serial number from the message's header. At 218, if that serial number matches the unique serial number in memory 122, then execution resumes at 220, which processes the particular command (e.g., turn on the laser 96, close the gripper 92, increase the speed of the motor 88, stop the motor 90), before execution resumes at 214. Otherwise, if the serial number is different from the unique serial number (i.e., the command message is for another robot), then step 214 is repeated.

### EXAMPLE 1

The implementation of the software on the controller 30 of FIG. 5 varies based on the particular game that is being implemented. However, at a high level, many implementations of the software have common functions.

FIG. 7 shows the functions of the exemplary controller game software 222, which accepts various inputs 224 and provides various outputs 226. The sensor data 228 is acquired by the sensors of the corresponding robot, such as 26, and is relayed by the RF transceivers 106,158 from the robot 26 to the controller 30. One example of such sensor data is the value from the robot's infrared detectors 81 when another robot, such as 28, “shoots” it with the infrared laser 96. The game data 230 (see FIG. 2) may include game-specific information sent from other controllers, such as 32, over the controller RF transceivers 158, which information applies to this controller 30. The user inputs 232 are values from the user's input device 160 (e.g., joystick; pushbuttons; firing control). The game software 222 processes these inputs 224 with logic that is specific to the game being played, and creates the robot command messages 182 (FIG. 5) and other various outputs 226 as shown in FIG. 7.

The robot command messages 182 are messages sent to the corresponding robot, such as 26, through the RF transceivers 158,106. The command messages 182 include, for example, settings for the robot motors 88,90, gripper 92, infrared laser 96, and other devices. The game data 236 are messages sent from the controller, such as 30, to other controllers, such as 32, over the controller RF transceivers 158, with information about the state of this controller and the game in general. The sound effects 238 may be sounds played by the game software through the sound support 174 in response to the events of the game, although not all games employ such effects. The graphics 234 on bus 172 may be overlaid on the video stream 164 returning from the corresponding robot. The LCD driver 166 manages the process of dynamically merging the two sets of data (i.e., graphics and video stream), although the invention is applicable to gaming systems, which do not employ graphics.

### EXAMPLE 2

Each game may have different logic, graphics and/or sound effects based upon the rules and/or theme of the game. There are an almost infinite variety of games that can be implemented by the exemplary gaming system 22.

The gaming system 22 may include optional components or objects that the robots 26,28 can sense with their sensors, or that have their own sensors and communications links, in order to act as part of a game. For example, such optional components or objects may include: (1) barriers, which are devices (e.g., specially colored tape; an infrared beam) that mark out geographic lines, which mobile gaming units can detect when such units or other sensor objects have crossed a line (e.g., to enable games to have concepts such as “out of bounds”, “finish lines”, “goals,” “bases”, “home bases”); (2) sensor objects, which are balls or other suitable objects (e.g., for sports games) with patterns or sensors that allow mobile gaming units to detect when they are holding or touching the same; (3) goals, which are fixed devices that can detect contact with mobile gaming units or sensor objects, and which transmit a wireless signal to the controllers 30,32, in order to inform them of the event (e.g., a sensor ball entering a goal).

The exemplary devices, as shown in FIG. 2, may communicate with each other in several ways: (1) Controller to Robot Commands—the controllers 30,32 send command messages 182 (e.g., without limitation, motor control; gripper control; firing control) to the corresponding robot(s) 26,28, which are currently being controlled; (2) Robot to Controller Sensor Data—the robot transmits sensor data messages 180 back to the corresponding controller with data or information about what the robot sensors have detected; (3) Robot to Controller Video—the video data 37 as captured by the robot video camera 34 is streamed to the corresponding controller in real time; (4) Controller to Controller Game Data—the controllers 30,32 of FIG. 2 exchange game specific data 230,236 (e.g., who shot whom; game scores) between themselves to keep the game in synch; and/or (5) Robot to Robot Infrared Shots—the robots 26,28 communicate directly using infrared beams 150 from the lasers 96 and to the corresponding sensors 81, which allows the robots to “shoot” each other. As another example, the proximity sensor 86 may be employed to detect another robot's proximity. Data gathered by the various robot sensors is transmitted back to the corresponding controller as Robot to Controller Sensor Data.

### EXAMPLE 3

In the exemplary embodiment of the gaming system 22, the Controller to Robot Commands, the Robot to Controller Sensor Data, and the Controller to Controller Game Data are all carried on the same channel by the radio frequency transceivers 158 and 106 in the controllers 30,32 and the robots 26,28, respectively. Each wireless message has a header, which identifies the particular device to which the message is intended, and the type of message. The various robots and controllers filter these messages based upon the header, in order to only act on the appropriate messages.

Also in the exemplary embodiment, because the video data 37 has a relatively higher bandwidth and is asymmetrical (i.e., is directed from the robot 26 to the controller 30), the video data 37 is sent from a dedicated robot RF transmitter 110 to a dedicated controller RF receiver 114.

### EXAMPLE 4

Typically, games are played by a group of users or players, each having a controller and a corresponding mobile gaming unit. A controller is preferably a computerized device with controls to allow a user to control the corresponding mobile gaming unit, and a display to view the video data and/or graphics associated with that mobile gaming unit. A mobile gaming unit is preferably a toy (e.g., a small vehicle), which is maneuvered remotely, and which transmits a stream of video data to the corresponding controller from the mobile gaming unit's video camera.

Preferably, the mobile gaming units transmit and receive wireless (e.g., infrared) signals to and from other mobile gaming units, in order to simulate weapons.

The users or players may control the mobile gaming units by watching the display of the corresponding controllers and by manipulating controls to send command messages to the mobile gaming units. The display may include the video data from the mobile gaming unit's video camera and/or a modified version of such video data.

### EXAMPLE 5

The rules of the game may be implemented as software that acts as the referee for the game. The firmware running in the mobile gaming units and the software running in the controllers communicate inputs from robot sensors (e.g., who shot whom, whether a mobile gaming unit crossed a particular barrier, such as a line or boundary), and the controllers track scores and determine who won the game. In addition, the game software may interact with the video data coming from the mobile gaming unit's video camera, in order to modify the video by superimposing a layer of graphics and/or text over the video image.

In addition, the game software may override the user's ability to control their mobile gaming unit based on events, such as refusing to drive if the mobile gaming unit is damaged, or refusing to fire until the user crosses a certain barrier. A wide variety of different software games may be provided for the gaming system, in order to give the mobile gaming units the ability to play diverse games.

### EXAMPLE 6

Video modifications may be done for one or more of several reasons: (1) Game Status—keeps the user up to date on the status of the game; (2) Robot Status—keeps the user informed on the status of their mobile gaming unit; (3) Communications—communicates with other users; (4) Themes—gives the user a sense that they are controlling something other than a toy robot; and (5) Interactivity—allows the user to interact with the game software in ways other than simply controlling the mobile gaming unit.

The Game Status may include, for example: (1) game score display; (2) status messages such as “You are it!”; (3) damage display, for example, by superimposing “cracks” (e.g., crooked black lines) or flames when the game software determines (based on the rules of the current game) that the mobile gaming unit is “damaged”; (4) damage report display, such as an outline of the mobile gaming unit, with damaged areas appearing in different colors (e.g., green for fine, yellow for damaged, red for disabled).

The Robot Status may include, for example: (1) a speedometer; (2) a damage report; and (3) a low battery warning for the mobile gaming unit.

The Communications may include, for example, chat messages from other users.

The Themes may include, for example, displaying graphics (e.g., a representation of the dashboard of a racing car; a heads up display from an airplane) around the edge of the display screen, in order to suggest that the user is “driving” something other than a toy robot. Such graphics may be photo-realistic or may employ a cartoon-like view depending on the feeling that the game maker is trying to convey.

The Interactivity may include, for example, displaying: (1) cross hairs showing the user what in the video data 37 will be hit when the user fires a weapon (e.g., the laser 96); (2) “lasers” and “missiles” when the user fires a weapon; (3) “explosions” when the user fires a weapon at another mobile gaming unit (e.g., if the video camera 34 is suitably lined up with a target in the game); (4) questions that the user must answer in order to continue; and (5) relatively smaller games that the user must play to continue.

For example, in a game where the user is “driving” a “racing car”, there may be a theme with a picture of a car's dashboard across the bottom of the display. Furthermore, a speedometer on the dashboard may show the mobile gaming unit's speed.

The exemplary gaming system 22 offers the advantages of video games (e.g., a neutral referee; gaming tournaments; excitement; tests of skill and coordination). In a conventional video game, the user is always aware that they are only interacting with software. Hence, the user is aware that a car crash, no matter how dramatic, is still just “bits”. In complete contrast, in the exemplary gaming system 22, the “Game is Real”. When a mobile gaming unit runs into a wall, or falls off a ledge, it is a very real event that the user or player sees (e.g., on the video display 156) from the point of view of the crash, and the other users or players see with their own “eyes” (e.g., on the other video displays 156).

### EXAMPLE 7

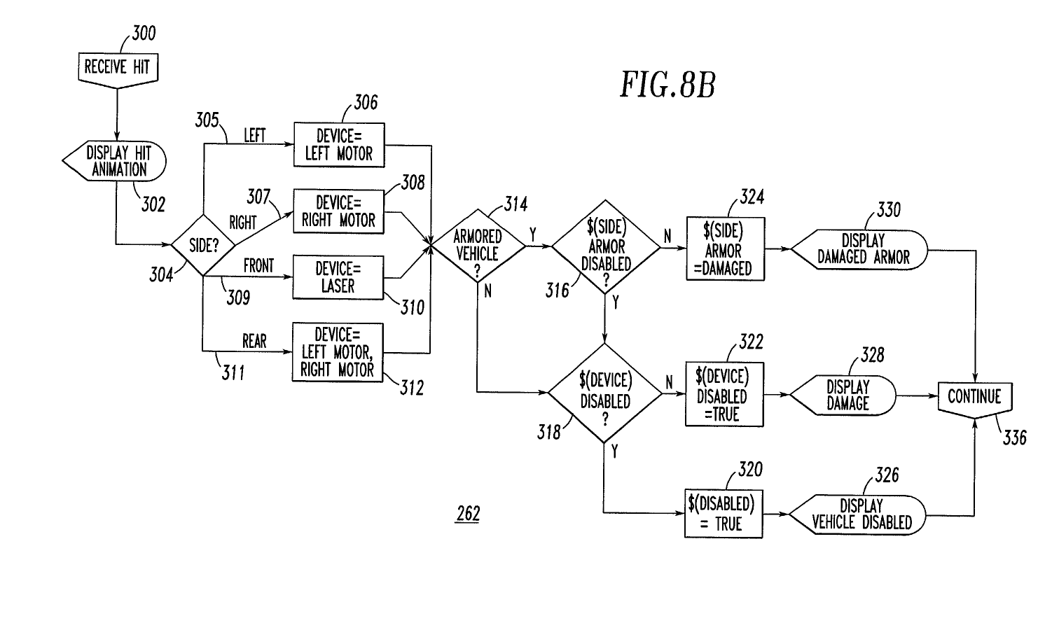

An example of a game for the gaming system 22 is a combat game. In this game, each user or player controls one mobile gaming unit, such as 26, and attempts to disable other mobile gaming units, such as 28, by “shooting” it (e.g., with the infrared laser 96 that is part of their robot 26). The users or players control their mobile gaming units 26,28 by watching the video display 156 on the corresponding controllers 30,32. This allows the users or players to see what the corresponding mobile gaming units “see” through the video cameras 34. Preferably, the display 156 superimposes graphics, which keep the users or players informed on the status of the corresponding mobile gaming unit. The game may be played until all but one of the mobile gaming units is disabled (e.g., as discussed below in connection with FIGS. 8A-8B).

FIG. 8A shows flowcharts of firmware executed by the robots 26,28 and of software executed by the controllers 30,32 for a combat game. At 240, the controller processor 154 detects that the user presses a fire button 241 on the controller 30 of FIG. 5. Next, at 242, it is determined if the corresponding “weapon” (e.g., the laser 96 of FIG. 4) is disabled. The disabled state of the laser 96 is discussed below in connection with steps 310 and 322 of FIG. 8B. If the weapon is disabled, then the weapon is not fired, at 244. Otherwise, if the weapon is not disabled at 242, then suitable graphics (e.g., as shown in FIG. 12) are output through the bus 172 to the LCD driver 166 and the display 156 in order to show the user that the weapon is fired. Contemporaneously, at 250, a fire RF message 251 (which is one of the command messages 182) is sent to the robot 26 through the controller RF transceiver 158. Next, at 252, the fire RF message 251 is received by the RF transceiver 106 of the robot processor 80. In response, the processor 80 activates the laser 96 for a suitable duration, at 254, in order to output a wireless signal, such as an infrared laser beam 255, from the robot 26 toward the other (targeted) robot 28.

In the event that the laser 96 was suitably aimed by the user through the display 156, then one or more of the sensors 81 of the targeted robot 28 detect the infrared laser beam 255 at 256. In response, at 258, a hit RF message 259 is sent to the controller 32 through the RF transceiver 106 of the robot 28. Next, at 260, the hit RF message 259 is received by the RF transceiver 158 of the processor 154 of the controller 32. In response, the processor 154 executes the process damage routine 262 of FIG. 8B. Contemporaneously, at 264, a damage RF message 265 is sent to the controller 30 through the controller RF transceiver 158. Next, at 266, the damage RF message 265 is received by the RF transceiver 158 of the processor 154 of the controller 30. In response, at 268, suitable graphics (e.g., as shown in FIG. 13) are responsively output through the bus 172 to the LCD driver 166 and the display 156 to display a representation of the weapon interacting with the robot 28 (e.g., a resulting “explosion” at the robot 28). Since the robot 26 employs the infrared laser beam 255, the corresponding controller 30 knows where the other robot 28 is (e.g., straight in front of the robot 26) at the instant that the “weapon” actually “hits” the other robot 28. The message 259 confirms receipt of the infrared laser beam 255, and the message 265 confirms receipt of the message 259.

Based upon which one (or more) of the sensors 81 detected the infrared laser beam 255, the “damaged” state of the robot 28 is suitably updated by the routine 262. Next, at 270, if the robot 28 is not completely disabled, then play of the game continues at 272. Otherwise, at 274, the robot 28 is shut down (e.g., no further command messages 182 are issued from the controller 32 to the robot 28; a shut down command (not shown) is sent from the controller 32 to the robot 28).

Even steps 276-294 are employed in the event that plural users or players are on the same “team”. At 276, it is determined if the robot 28 was the last member of the corresponding team to be disabled.. If not, then a disabled RF message 279 is responsively sent to the controller 30 through the RF transceiver 158. Next, at 280, the disabled RF message 279 is received by the RF transceiver 158 of the processor 154 of the controller 30. In response, at 282, the “score” of the game is suitably adjusted (e.g., incremented) to show that the team associated with the robot 26 has disabled the robot 28 associated with the other team. In turn, at 284, a suitable message (e.g., a new game score) is displayed to the user on the display 156 of the controller 30.

On the other hand, if the robot 28 was the last member of the corresponding team to be disabled at 276, then a “game over” state is set at 286 and, at 288, a game over RF message 289 is responsively sent to the controller 30 through the RF transceiver 158. Contemporaneous with step 288, at 290, a “game over” message is responsively displayed to the user on the display 156 of the controller 32. Next, at 292, the game over RF message 289 is received by the RF transceiver 158 of the processor 154 of the controller 30. In response, at 294, the “game over” message is responsively displayed to the user on the display 156 of the controller 30.

As shown in FIG. 8B, the process damage routine 262 responds to the message 259 of FIG. 8A, at 300, which confirms receipt of the infrared laser beam 255 by the targeted robot 28. In response, a suitable animation is displayed, at 302, on the display 156 of the corresponding controller 32. For example, the sound effects 238 (FIG. 7) and/or the animation may suggest (e.g., through flashing red color; shaking of the vehicle overlay graphics) that the robot 28 has been “hit” by a “weapon”.

Next, at 304, it is determined which of the sensors 81 of the targeted robot 28 detected the infrared laser beam 255. The controller 32 of the targeted robot 28 evaluates a set of rules, in order to determine what to show to its user. For example, the robots 26,28 may have the sensors 81 on different sides, each of which has a different effect on the robot if a weapon's “hit” is detected by the software. As a more particular example, the sensors 81 may include: (1) left side—left motor 88; (2) right side—right motor 90; (3) front side—laser 96; and (4) rear side—both motors 88,90. In turn, the hit RF message 259 may be encoded to indicate which of the left side, right side, front side or rear side sensors 81 detected the beam 255. Step 304 parses the RF message 259, in order to determine: (1) the left side state 305 for the left motor at 306; (2) the right side state 307 for the right motor at 308; (3) the front side state 309 for the laser at 310; and (4) the rear side state 311 for both the left and right motors at 312.

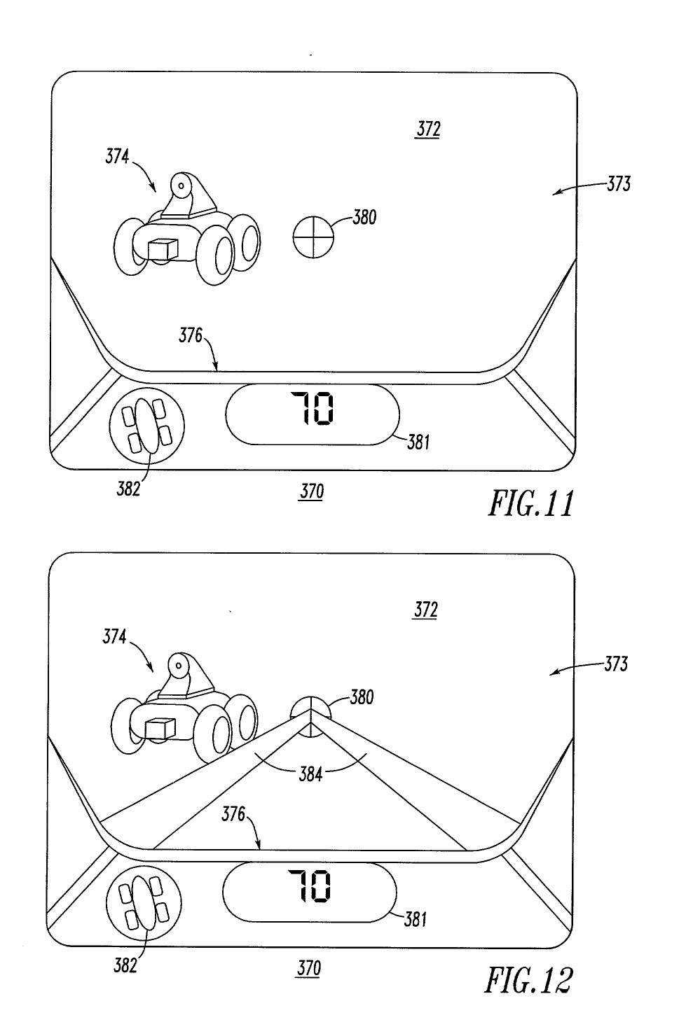

Internally, the game software maintains a data structure for the corresponding robot, such as 28, which structure tracks the damage to each of the three devices (e.g., left motor 88; right motor 90; laser 96). When the game begins, each user may be presented with a screen (not shown) that allows the user to choose a type of vehicle. While physically, every player is controlling a similar mobile gaming unit, the software can alter the behavior of the mobile gaming unit to simulate the choice of different vehicles. For example, the player can choose one of two options: (1) Fast Vehicle (as discussed below in connection with FIG. 10); or (2) Armored Vehicle (as discussed below in connection with FIG. 11). If the user has selected an “Armored Vehicle,” then the first “hit” to any given side simply results in the “armor” on that side being disabled.

At 314, it is determined if the user selected an “Armored Vehicle”. If so, then at 316 it is determined if the armor for the determined side at 304 was previously damaged. If the armor for the determined side was previously damaged, or if the user did not select an “Armored Vehicle”, then, at 318, if the corresponding one of the three devices (e.g., left motor 88; right motor 90; laser 96) is already disabled, then the robot is disabled at 320. For example, if the mobile gaming unit is shot on the left side when the left motor 88 is already damaged, then the entire unit becomes disabled at 320. In the case of an “Armored Vehicle” being shot on the left side, the first shot damages the “armor,” the second shot disables the left motor 88, and the third shot disables the whole unit. In the case of a “Fast Vehicle” being shot on the left side, the first shot disables the left motor 88, and the second shot disables the whole unit. If the test at 318 is true, then the state of the robot 28 is set to “disabled” at 320. Next, the disabled state is displayed, at 326, on the display 156, before the routine 262 returns at 336. Otherwise, at 318, if it is determined that the corresponding one of the three devices (e.g., left motor 88; right motor 90; laser 96) is newly disabled, then the state of that device is set to “disabled” at 322. Next, the disabled state of that device is displayed, at 328, on the display 156, before the routine 262 returns at 336. On the other hand, if it is determined, at 316, that the armor of one of the four sides (e.g., left, right, front, rear) is newly damaged, then the state of that armor is set to “damaged” at 324. Next, the damaged state of that armor is displayed, at 330, on the display 156, before the routine 262 returns at 336.

For example, assuming that the user did not select an “Armored Vehicle” or that the “armor” for a particular side was damaged, receipt of the infrared laser beam 255 at the left side sensor 81 or the right side sensor 81 results in the left side motor 88 or the right side motor 90, respectively, being disabled at 322. Similarly, receipt of the infrared laser beam 255 at the rear side sensor 81 results in both the left side and the right side motors 88,90 being disabled at 322. Similarly, receipt of the infrared laser beam 255 at the front side sensor 81 results in the laser 96 being disabled at 322.

### EXAMPLE 8

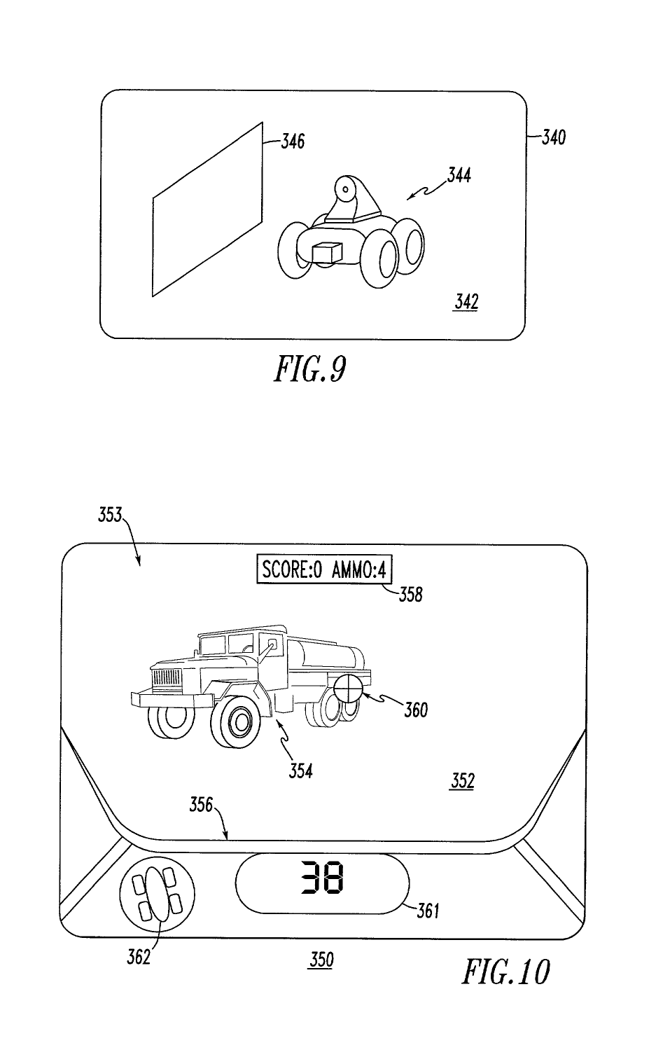

FIG. 9 shows a representation 340 of a video display of a gaming environment 342 as captured by the video camera 34 of the robot 26 and displayed on the display 156 of the corresponding controller 30 of FIG. 2. The representation 340 is an example of one frame of video as captured by the video camera 34, without any modification by the controller 30. The portion of the gaming environment 342 of the video display representation 340 includes another robot 344 and a barrier 346. The representation 340 is useful in that the user or player associated with the robot 26 can determine the position of the other robot 344 and/or the barrier 346 within the gaming environment 342. Furthermore, the user or player associated with the robot 26 can determine the position of the robot 26 with respect to the other robot 344 and/or the barrier 346. For example, in a particular game, it might be advantageous to “hide” from the other robot 344 (e.g., behind the barrier 346).

### EXAMPLE 9

FIG. 10 shows a representation 350 of another video display of a gaming environment 352 as captured by the video camera 34 of the robot 26 and displayed on the display 156 of the corresponding controller 30 of FIG. 2. The representation 350 is an example of one frame of video 353 as captured by the video camera 34, with modifications in the form of computer-generated graphics by the controller 30. The representation 350 includes both the gaming environment 352, which shows another robot 354, and computer-generated graphics for a superimposed dashboard 356. Further computer-generated graphics may be provided to modify the gaming environment 352 to include game related messages 358 (e.g., game score; remaining ammunition; status of the game) and a cursor 360 for aiming the weapon (e.g., a bulls-eye for the laser 96; a representation of cross hairs for aiming a weapon at another mobile gaming unit).

The exemplary dashboard 356 is suggestive of a “Fast Vehicle” (as discussed above in connection with FIG. 8B) and provides a speedometer 361 having a maximum speed of 100 (e.g., a lower speed of 38 out of 100 is displayed). When the user selects this “Fast Vehicle”, the robot 26 may drive up to its maximum speed, but will only take a minimum amount of damage (as discussed above in connection with FIG. 8B). The dashboard 356 also includes a damage report graphic 362, which indicates the damage to the motors 88,90 and laser 96 (as discussed above in connection with FIG. 8B).

### EXAMPLE 10

FIG. 11 shows a representation 370 of another video display of a gaming environment 372 as captured by the video camera 34 of the robot 26 and displayed on the display 156 of the corresponding controller 30 of FIG. 2. The representation 370 is an example of one frame of video 373 as captured by the video camera 34, with modifications in the form of computer-generated graphics by the controller 30. The representation 370 includes both the gaming environment 372, which shows another robot 374, and computer-generated graphics for a superimposed dashboard 376. Further computer-generated graphics may be provided to modify the gaming environment 372 to include a cursor 380 for aiming the weapon. In this example, the cursor 380 is aimed away from the robot 374. The user may advantageously employ the display 156 to determine the position of the other robot 374 in the gaming environment 372.

The exemplary dashboard 376 is suggestive (e.g., a heavy-looking metallic dashboard (not shown)) of an “Armored Vehicle” (as discussed above in connection with FIG. 8B) and provides a speedometer 381 having a maximum speed of 70 (e.g., a speed of 70 out of 70 is displayed). This simulates the relatively slower speed of the robot 26 because of the extra “armor” that it carries. The software of the game only allows the robot 26 to go to 70% of its maximum speed. However, the software also makes the robot 26 take a larger amount of damage before disabling it (as discussed above in connection with FIG. 8B).

The dashboard 376 also includes a damage report graphic 382 (which is in a normal state in FIG. 11), which otherwise indicates armor damage (e.g., yellow) if any of the four sides of the “armor” (which is in a normal state in FIG. 11) is damaged and device damage (e.g., red) if any of the motors 88,90 and laser 96 is damaged (as discussed above in connection with FIG. 8B).

As discussed above in connection with FIG. 8A, after the game begins, whenever the user presses the fire button 241 on the controller 30, a message is passed to the game software, which interprets the message as a command to fire the robot's laser 96. The game software checks whether this weapon is enabled (e.g., true by default; disabled by damage as discussed above in connection with FIG. 8B), and then, if enabled, sends a fire RF message 251 through the RF transceivers 158,106 to the robot 26 to fire the laser 96. As shown in FIGS. 12 and 13, the controller 30 also displays an animation 384, which represents shots being fired from one or more laser 96 “weapons” on the robot 26.

When the robot 26 receives the fire RF message 251, it activates its forward facing infrared laser 96. Preferably, the robot modulates the resulting infrared laser beam 255 to encode the robot's unique serial number (e.g., a one-byte number; a plural-byte number) in the laser pulse. If there is another robot, such as 28 or 374 in the path of the beam 255, its sensors 81 detect the pulse. In turn, the robot processor 80 records the modulated number and employs its own RF transceiver 106 to send that number back to its own controller 32.

One feature of the combat is that a robot, such as 28, knows whether it has been it is “hit” and communicates this through its controller, such as 32, to the other robot's controller, such as 30. The receiving controller 32 acts according to its own damage rules, and relays the damage RF message 265 to the controller 30 of the firing player, in order to indicate that the targeted robot 28 was, in fact, “hit” by the beam 255.

### EXAMPLE 11

FIG. 12 is similar to FIG. 11, except that representations 384 (e.g., red color) of “lasers” or “weapons” are superimposed, in order to represent the firing of a weapon (e.g., aimed at about another one of the robots 374). The “lasers” or “weapons” in this example do not hit the other robot 374 and, hence, there is no explosion (as represented at 386 of FIG. 13).

### EXAMPLE 12

FIG. 13 is similar to FIG. 12, except that the “lasers” or “weapons” in this example hit the other robot 374 and, hence, there is an explosion, which is represented (e.g., yellow) at 386. This representation 386 results from the firing of a weapon (e.g., the laser 96) at another one of the robots, such as 28. If the firing controller 30 receives a hit RF message (or the damage RF message 265 of FIG. 8A) from the other controller 32, which message indicates that the firing robot 26 hit the targeted robot 28 of the other controller 32, then the user is shown the animation of FIG. 13, which graphically shows the user that they did hit the other robot 28. This representation 386 shows the laser weapon (as represented at 386) interacting with the robot 374 and is suggestive of damage to that robot.

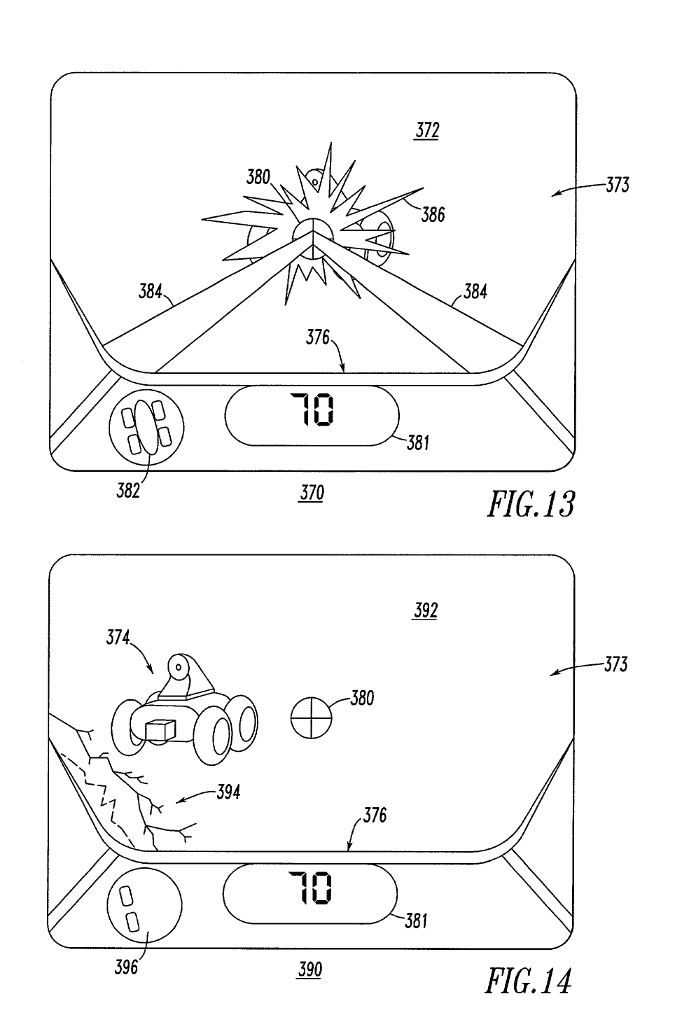

FIGS. 14-16 show representations 390,400,410 of damage to one of the mobile gaming units.

### EXAMPLE 13

The representation 390 of FIG. 14 shows the display of a representation 392 of a windshield of one of the mobile gaming units. The representation 392 includes a representation 394 of damage (e.g., minor and major cracks) to the left side of the windshield. For example, on any hit to a particular side of a Fast Vehicle (not shown), or on a second hit to that side of an Armored Vehicle, the damage disables the corresponding device. For example, as discussed above in connection with FIG. 8B, the damage to the left side (e.g., as shown by the major cracks) disables the left motor 88 of the robot 26, which corresponds to this display. This is also shown by the damage report graphic 396, which is illuminated (e.g., red) on the left side. A wide range of other modifications to the left side may be employed (e.g., dents; blackened parts; bullet holes; cracks to the windshield, dashboard or other portions of the display). At this point, the game software ignores any commands from the user that employ the disabled device. For example, if the left motor 88 is disabled, and the user sends a forward command, then only the right motor 90 is energized, thereby leaving the robot 26 spinning in a circle.

### EXAMPLE 14

The representation 400 of FIG. 15 shows the display of a representation 402 of a windshield of one of the mobile gaming units. The representation 402 includes a representation 404 of damage (e.g., minor cracks) to the left side of the windshield and/or minor dents (not shown) on the left side of the windshield. For example, on a first hit to that side of an Armored Vehicle, the damage is to the “armor” on that side. This is also shown by the damage report graphic 406, which is illuminated (e.g., yellow) on the left side. In this example, the devices (e.g., the motors 88,90 and laser 96) of the robot 26 remain operational.

### EXAMPLE 15

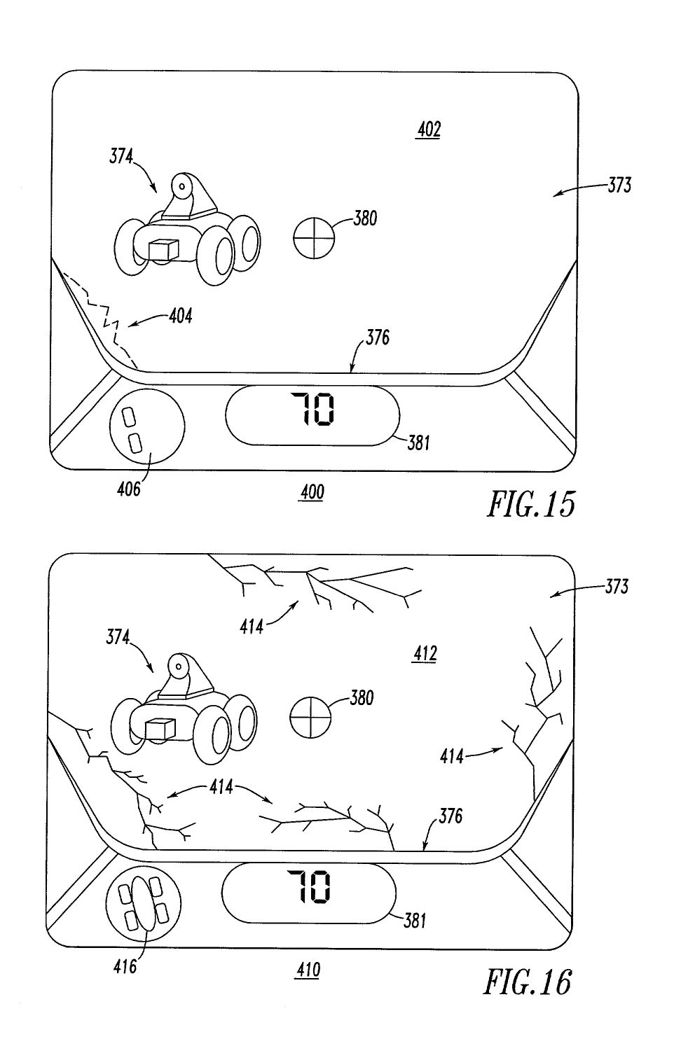

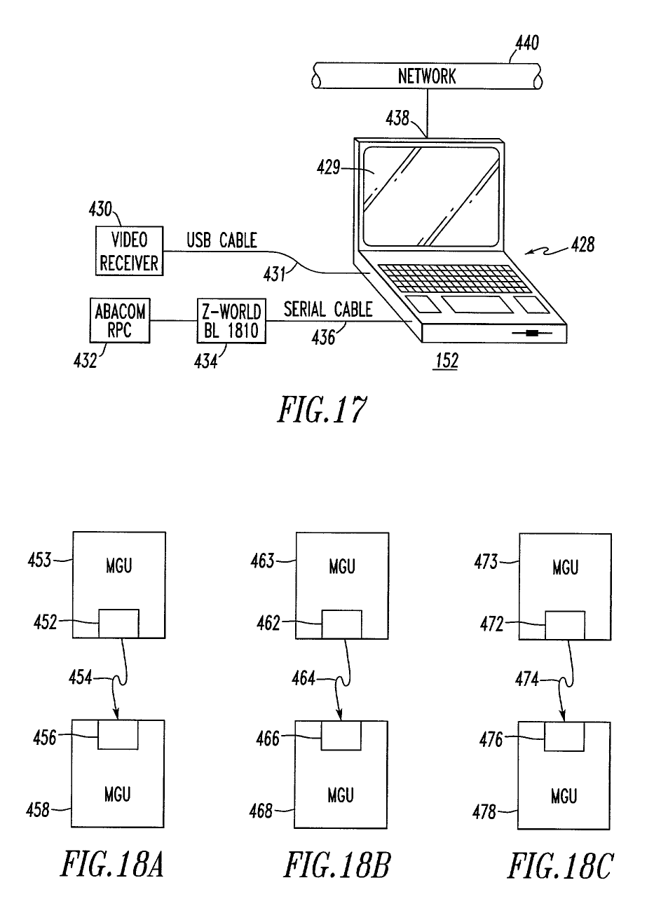

The representation 410 of FIG. 16 shows the display of a representation 412 of a windshield of one of the mobile gaming units. The representation 412 includes a representation 414 of damage (e.g., major cracks) to the left, right, top and bottom of the windshield. A wide range of other representations of damage may be employed (e.g., the dashboard graphic may be modified to look like the mobile gaming unit has been totaled; black cracks make the windshield appear to be shattered; the metal portion of the dashboard may be dented, blackened and/or torn open to expose a view of wiring inside). For example, as discussed above in connection with FIG. 8B, the damage to all four sides disables the left and right motors 88,90 and laser 96 of the robot 26, which corresponds to this display. This is also shown by the damage report graphic 416, which is illuminated (e.g., red) on all four sides. In this example, the devices (e.g., the motors 88,90 and laser 96) of the robot 26 are not operational and such robot is completely disabled. Once all three devices are disabled, the robot is considered to be out of play. At this point, the corresponding controller sends a message (e.g., disabled RF message 279 of FIG. 8A) to that effect to the other controllers. When all but one robot has been put out of the play, all of the players are shown a “Game Over” screen (e.g., as discussed in connection with steps 290,294 of FIG. 8A), which shows which player won (e.g., “Player 3 Wins” (not shown)). Preferably, the screen gives the user the option to “Press any key to start over” (not shown).

### EXAMPLE 16

Each user may control a plurality of mobile gaming units (e.g., two, three or more), by switching between them from the controllers. This enables strategy games where players strategically place their mobile gaming units in positions, and switch between them to control the optimal mobile gaming unit (e.g., the one having the most ammunition; the least damage; the best position in the gaming environment) at any given time.

### EXAMPLE 17

The controller may be a handheld computing device (e.g., the controllers 30,32 of FIG. 2), a personal computer 428 (e.g. as discussed below in connection with FIG. 17), or another non-handheld computing device.

### EXAMPLE 18

As an alternative to FIG. 5, the video stream 164 may go through the controller processor (e.g., 154 of FIG. 5) or CPU, thereby allowing the corresponding hardware and/or software to apply new special effects directly on the video (e.g., zooming in on a part of the image; scaling down the image to take up, for example, only a quarter of the screen; creating “Lens” effects, in order to distort the view). This approach may require significantly more powerful and, therefore, more expensive computing in the controller. However, if the controller is a personal computer (e.g., as discussed below in connection with FIG. 17), this is not a significant issue since conventional PCs typically have sufficient computational power to deal with real-time video streams.

### EXAMPLE 19

As alternatives to the example displays of FIGS. 10-16, for controllers, which have suitably large display screens, the graphics may not only overlay the video, but may surround it as well.

### EXAMPLE 20

The mobile gaming units may employ a plurality of video cameras (e.g., two, three or more), in order to look in more than one direction, or to create a stereo image, such that the users or players may have depth perception from the video display.

### EXAMPLE 21

As an alternative to FIG. 2, the communication network, through which the mobile gaming unit is controlled, does not need to be a simple wireless network. Any suitable communication network may be employed, such as, for example, a local area network, the Internet, or a combination of communication networks (e.g., by sending messages from a local PC over the Internet to a wireless network in a remote gaming environment, such as an arena).

### EXAMPLE 22

As an alternative to the sensors of FIG. 4, a wide variety of sensors may be employed on the mobile gaming units to feed into the game software (e.g., radar; sonar; infrared proximity sensors; image recognition; touch bumpers; laser range finders).

### EXAMPLE 23

As alternatives to the robots 26,28 of FIG. 2, mobile gaming units may have a wide variety of possible shapes, sizes and modes of transportation, for example, by employing treads; by walking (e.g., on legs), swimming, flying, hovering (e.g., a toy hovercraft; a blimp), floating, or rolling.

### EXAMPLE 24

As alternatives to the PROM socket 162 and PROM 163 of FIG. 5, the controllers may preferably employ a wide range of changeable gaming software (e.g., removable game cartridges; CD-ROMs; non-volatile memory, which may be downloaded from the Internet).

### EXAMPLE 25

Although changeable gaming software is disclosed, the gaming system may employ controllers and/or mobile gaming units having a fixed game implementation, which is permanently built into such devices.

### EXAMPLE 26

Although FIGS. 4 and 5 show an RF transmitter 110, an RF receiver 114, and RF transceivers 106,158 (each of which has a transmitter and a receiver), the mobile gaming units and controllers may employ a single communications link (e.g., each having a single antenna) having a plurality of logical links (e.g. for commands; video; sensor data).

### EXAMPLE 27

Although FIGS. 14-16 show damage to the mobile gaming unit associated with a particular controller, the video display may show simulated damage to another mobile gaming unit on that video display. In this example, the controller knows the position of the other mobile gaming unit with suitable precision, along with its angle, and whether there is any intervening object(s). Suitable sensors include radar, and high resolution GPS.

### EXAMPLE 28

As one example of possible rules for a game, when a mobile gaming unit is hit by a “weapon” from another mobile gaming unit, the video display at the corresponding controller flashes red (e.g., a video modification) and a pop-up message states that the corresponding mobile gaming unit must return to its “home base” before it can fire again. That message is removed when the mobile gaming unit detects that it has reached its home base.

### EXAMPLE 29

As another example of possible game rules, when a mobile gaming unit is hit by a “weapon” from another mobile gaming unit, the video display at the corresponding controller displays “cracks” (e.g., crooked black lines) on the video display “windshield” corresponding to the side (e.g., left or right) of such mobile gaming unit that was “hit” by the weapon. In turn, the corresponding motor for that side is disabled or stopped for a predetermined period (e.g., about ten seconds), after which the “damage” is “repaired”.

### EXAMPLE 30

As another example, the game rules are similar to those of Example 29, except that the mobile gaming unit has “Armor”. When the mobile gaming unit is hit by the “weapon” from the other mobile gaming unit, then the first hit on either side simply produces a warning message (e.g., superimposed over the video display) that the armor on that side has been damaged. The second and subsequent hits on that side function in the same manner as discussed above in connection with Example 29. Preferably, the mobile gaming units that choose the “Armor” option can only drive at a fraction (e.g., without limitation, about 70% of full speed), in order to simulate the “weight” of the “Armor”.

### EXAMPLE 31

As a further example of the robots 26,28 of FIG. 2, the mobile gaming unit may include: (1) an X10 wireless video camera with wireless transmitter (marketed by www.x10.com) as the video camera 34 and transmitter 110; (2) a Z-World Jackrabbit BL1810 Single Board Computer (marketed by www.zworld.com) as the processor 80; and (3) one or more Abacom BIM-RPC-433 RF Transceivers (marketed by www.abacom-tech.com) as the transceiver 106.

For example, the robot 26 may be controlled by the Z-World BL1810 Single Board Computer. The BL1810 controls the motors 88,90 and reads from the sensors 81,82,84,86. The robot 26 employs the Abacom transceiver 106 to relay sensor information back to the controller 30, and to receive motor and firing commands from such controller.

The X10 wireless camera may be mounted on top of the robot 26, and facing in the same direction as the front of such robot.

The laser 26 (e.g., red; infrared) may also be forward facing. Preferably, the laser beam 150 passes through a simple convex lens (not shown) to diffuse such beam in order to make it spread enough to ensure hitting one of the sensors 81 on any of the targeted mobile gaming units.

The sensors 81 are preferably photodetectors with red filters (not shown). These sensors 81 may be suitably studded around the edge of the mobile gaming unit.

### EXAMPLE 32

Referring to FIG. 17, the controller 152 may be implemented as a personal computer (PC) 428 having a suitable display 429. The PC 428 may run a program implemented in the Java programming language. The controller 152 may also include a suitable video receiver 430 (e.g., X10 Wireless video receiver) interconnected with the USB port of the PC 428 by a USB cable 431. This allows the PC 428 to receive the video data from the video camera 34 of the mobile gaming unit. The controller 152 may further include a suitable wireless transceiver, such as an Abacom RPC 432, and a Z-World BL1810 computer 434, which are interconnected with the serial port of the PC 428 by a serial cable 436. The software on the computer 434 simply relays information between the wireless transceiver 432 and the PC 428.

### EXAMPLE 33

The software components of the controller 152 of FIG. 17 may include: (1) Java Runtime Environment (version 1.4.0); (2) Java Media Framework (version 2.1.1a); (3) Java Communications API (version 2.0); and (4) X10 Video Drivers.

The main program runs on the PC 428 and allows the user to play robotic games by controlling their mobile gaming unit, viewing the video from the mobile gaming unit, and interacting with the game itself through commands and graphics.

The main program employs the Java Media Framework in order to receive and interact with the video stream from the video camera of the mobile gaming unit. By employing Java Media Frame methods, the program may create a graphical component that displays the video stream from the mobile gaming unit. The program then employs the Java2D API (a graphics library built into the Java Runtime Environment) to superimpose graphics on top of the video component.

The main program employs the Java Communications API to allow the program to interact with the computer 434 connected to its serial port in order to communicate with the corresponding processor 80 on the mobile gaming unit.

In addition, the software employs the computer's network connection 438 in order to communicate with other computers (e.g., other controllers (not shown)) on the same network 440, which are also controlling mobile gaming units. This link is employed for communicating game-related data (e.g., scores, who hit whom).

The controller software integrates these different elements to allow players to control their mobile gaming units and play games. The software implements rules for the games, which are fed data from the other player's controllers, the mobile gaming unit's sensors, and the player's commands. Based on these inputs, the software may superimpose graphics, send messages to other controllers, and control the mobile gaming units.

### EXAMPLE 34

Although FIG. 4 shows a robot 26 including a laser 96 having a laser beam 150 as received by one or more corresponding sensors 81 of another mobile gaming unit, such as robot 28, a wide range of wireless outputs, wireless signals and wireless sensors may be employed. For example, FIG. 18A shows an infrared transmitter (e.g., an infrared LED) 452 on one mobile gaming unit 453, which sources an infrared signal 454 to an infrared receiver 456 on another mobile gaming unit 458. FIG. 18B shows an ultrasonic transmitter 462 on one mobile gaming unit 463, which sources an ultrasonic signal 464 to an ultrasonic receiver 466 on another mobile gaming unit 468. FIG. 18C shows a radio frequency (RF) transmitter 472 on one mobile gaming unit 473, which sources an RF signal 474 to an RF receiver 476 on another mobile gaming unit 478. Preferably, the ultrasonic signal 464 and the RF signal 474 have limited ranges and/or sound or RF absorbing barriers (not shown) are employed as part of the corresponding gaming environment.

### EXAMPLE 35

Although FIG. 2 shows a robot 26 including motors 88,90 (shown in FIG. 4) driving wheels 89,91, respectively, on a surface (not shown) of a gaming environment, a wide range of mechanisms for moving a mobile gaming unit on a surface may be employed. For example, as shown in FIG. 19, the mobile gaming unit may be a vehicle, such as a tank 480 including a pair of treads 482,484, which are driven by the motors (M) 88,90, respectively.

### EXAMPLE 36

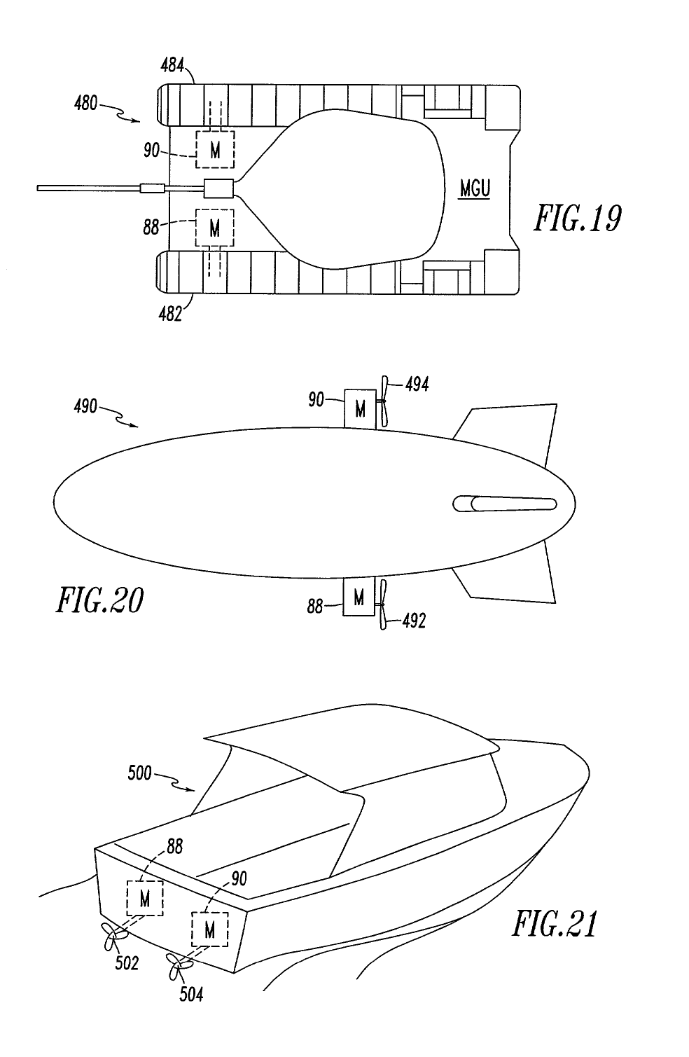

Although FIGS. 2 and 19 show mobile gaming units 26,480 having mechanisms for movement on a surface, a wide range of mechanisms for moving a mobile gaming unit above a surface may be employed. For example, as shown in FIG. 20, the mobile gaming unit may be a hovering craft, such as a blimp 490 including a plurality of propellers 492,494, which are driven by the motors (M) 88,90, respectively.

### EXAMPLE 37

Although FIGS. 2, 19 and 20 show mobile gaming units 26,480,490 having mechanisms for movement on or above a surface, a wide range of mechanisms for moving a mobile gaming unit on or in a liquid may be employed. For example, as shown in FIG. 21, the mobile gaming unit may be a submarine or boat 500 including a plurality of propellers 502,504, which are driven by the motors (M) 88,90, respectively.

### EXAMPLE 38

Although FIG. 9 shows a visible, passive barrier 346, a wide range of invisible and/or active barriers may be employed for the mobile gaming units. For example, any suitable object (e.g., a chair; a wall) may be employed to define a visible boundary; a piece of colored tape or fabric may be employed to visibly mark a geographic line (e.g., for detection by the user through the video camera 34 and display 156); an infrared beam 510 (FIG. 4) from a infrared source 512, which is detectable by an infrared sensor, such as 84 of the robot 26, may be employed to “mark” an invisible, but detectable, barrier; and an ultrasonic signal (not shown), which is detectable by an ultrasonic sensor (not shown) of the robot 26, may be employed to “mark” an invisible, but detectable, barrier.

### EXAMPLE 39

Although FIG. 4 shows one or more sensors, such as infrared sensors 81,84, an RF sensor 82, and a proximity sensor 86, a wide range of sensors may be employed to detect other active or passive objects. For example, radar sensors, sonar sensors, infrared proximity sensors, image recognition sensors, a touch sensor (e.g., a touch bumper), and range finder sensors (e.g., laser range finders) may be employed.

### EXAMPLE 40

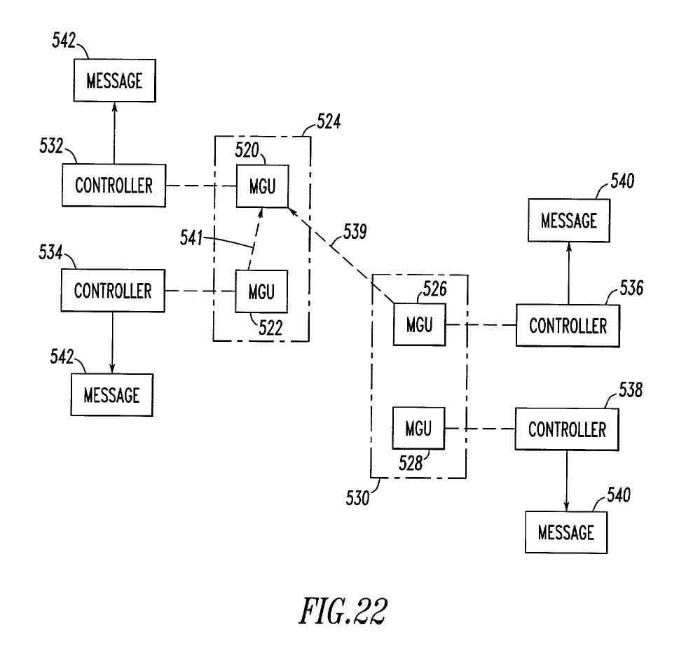

FIG. 22 shows first and second mobile gaming units 520,522 on a first team 524, and third and fourth mobile gaming units 526,528 on a second team 530. Plural controllers 532,534,536,538 are employed for the respective mobile gaming units 520,522,526,528. In a similar manner to the communications discussed above in connection with FIG. 8A, whenever one of the mobile gaming units 520,522 of the first team 524 is disabled by a weapon 539 fired from one of the mobile gaming units 526,528 for the second team 530, a message 540 is responsively displayed at the controllers 536,538 for the second team 530. In a like manner, whenever one of the mobile gaming units 520,522 of the first team 524 is disabled by a weapon 541 for that first team 524 (e.g., “friendly fire”), a message 542 is responsively displayed at the controllers 532,534 for the first team 524. Preferably, the unique serial number of the firing mobile gaming unit is encoded (e.g., as a series of repeating serial bits) in the wireless signal associated with the weapons 539,541.

The exemplary gaming system 22 preferably combines sensor data and a video stream from a remote mobile gaming unit with computer graphics in order to allow users to play computer-moderated games with the mobile gaming units.

It will be appreciated that while reference has been made to the exemplary controller processor 154 and controller personal computer 428, a wide range of other processors such as, for example, mainframe computers, mini-computers, workstations, personal computers (PCs), microprocessors, microcomputers, and other microprocessor-based computers may be employed. For example, any suitable Internet-connected platform or device, such as a wireless Internet device, a personal digital assistant (PDA), a portable PC, or a protocol-enabled telephone may be employed.

It will be appreciated that while reference has been made to the exemplary mobile gaming unit processor 80, a wide range of other suitable digital and/or analog processors may be employed. For example, the controller processor 154 may provide some or all of the digital processing. The mobile gaming unit may receive analog radio signals to control the mobile gaming unit motors 88,90 (e.g., like a remote control toy car or toy plane) and send analog radio signals including data from the mobile gaming unit sensors and/or analog video information from the mobile gaming unit video camera. Hence, the mobile gaming units need not employ a digital processor.

While for clarity of disclosure reference has been made herein to the exemplary video displays 156,429 for displaying another mobile gaming unit and/or the gaming environment of the gaming system 22, it will be appreciated that all such information may be stored, printed on hard copy, be computer modified, be combined with other data, or be transmitted for display elsewhere. All such processing shall be deemed to fall within the terms “display” or “displaying” as employed herein.

While specific embodiments of the invention have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the invention which is to be given the full breadth of the claims appended and any and all equivalents thereof.

What is claimed is:

1. A gaming system for a gaming environment, said gaming system comprising:
a plurality of mobile gaming units, each of said mobile gaming units comprising
a first communication link for at least a plurality of messages and a video output,
means for moving said mobile gaming unit responsive to an input,
a processor receiving at least some of said messages and providing the input of said means for moving,
a video camera providing the video output including a representation of at least one of: (a) another one of said mobile gaming units, and (b) at least a portion of said gaming environment, and
a power source; and
a plurality of controllers for said mobile gaming units, each of said controllers comprising
a second communication link in communication with at least one of said first communication links for at least said messages and said video output,
a display displaying said video output from said second communication link,
an input device having an output, and
a processor receiving the output of said input device and providing at least some of said messages.

2. The gaming system of claim 1 wherein said first communication link comprises a first radio frequency transmitter having an input, a first radio frequency receiver having an output, and a second radio frequency transmitter transmitting said video output; wherein said second communication link comprises a second radio frequency receiver tuned to at least one of said first radio frequency transmitters, said second radio frequency receiver having an output, a third radio frequency transmitter tuned to at least one of said first radio frequency receivers, said third radio frequency transmitter having an input, and a third radio frequency receiver tuned to one of said second radio frequency transmitters, said third radio frequency receiver receiving said video output; wherein the processor of said mobile gaming units provides the input of said first radio frequency transmitter, and receives the output of said first radio frequency receiver; wherein said display displays said video output from said third radio frequency receiver; and wherein the processor of said controllers receives the output of said second radio frequency receiver, and provides the input of said third radio frequency transmitter.

3. The gaming system of claim 1 wherein said processor of said mobile gaming units comprises
a wireless output having an input and a responsive wireless signal,
a sensor sensing at least one of the wireless signals of another one of said mobile gaming units, said sensor having an output, and
a microcomputer including an output providing the input to said wireless output, and an input receiving the output of said sensor.

4. The gaming system of claim 3 wherein the output of said sensor includes sensor data to the input of said microcomputer; and wherein some of said messages include said sensor data for at least one of said controllers.

5. The gaming system of claim 1 wherein said processor of said controllers comprises means for generating commands; and wherein some of said messages include the commands from one of said controllers to one of said mobile gaming units.

6. The gaming system of claim 1 wherein said first communication link and said second communication link are tuned to at least each other.

7. The gaming system of claim 6 wherein said processor of said mobile gaming units comprises a wireless output having a wireless signal; and wherein said commands are selected from the group comprising a first command for controlling said means for moving, and a second command for controlling said wireless output.

8. The gaming system of claim 1 wherein said means for moving includes a plurality of wheels, and a plurality of motors driving said wheels.

9. The gaming system of claim 8 wherein said processor of said mobile gaming units comprises means for controlling said motors.

10. The gaming system of claim 1 wherein said means for moving includes a plurality of treads, and a plurality of motors driving said treads.

11. The gaming system of claim 10 wherein said processor of said mobile gaming units comprises means for controlling said motors.

12. The gaming system of claim 1 wherein said gaming environment includes at least one barrier for at least one of said mobile gaming units.

13. The gaming system of claim 1 wherein the video output of said video camera includes a representation of at least one of another one of said mobile gaming units.

14. The gaming system of claim 1 wherein the video output of said video camera includes a representation of at least one of another one of said mobile gaming units and said gaming environment.

15. The gaming system of claim 1 wherein the video output of said video camera includes a representation of said gaming environment.

16. The gaming system of claim 3 wherein said wireless signal is selected from the group comprising a laser signal, an infrared signal, an ultrasonic signal, and a radio frequency signal.

17. The gaming system of claim 1 wherein said power source is a battery.

18. The gaming system of claim 1 wherein said display is a video display.

19. The gaming system of claim 1 wherein said input device includes at least one of a joystick, and a plurality of pushbuttons.

20. The gaming system of claim 3 wherein said wireless output is selected from the group comprising a laser, an infrared transmitter, an ultrasonic transmitter, and a fourth radio frequency transmitter.

21. The gaming system of claim 1 wherein said controller is selected from the group comprising a personal computer, and a handheld device.

22. The gaming system of claim 1 wherein said processor of said controllers comprises a microcomputer, means for storing a game, and means for receiving said means for storing a game.

23. The gaming system of claim 1 wherein said processor of said mobile gaming units comprises a sensor, which is selected from the group comprising a radar sensor, a radio frequency sensor, an ultrasonic sensor, a sonar sensor, an infrared sensor, a proximity sensor, an image recognition sensor, a touch sensor, and a range finder sensor.

24. A gaming method for a gaming environment, said method comprising:
employing a plurality of mobile gaming units;
employing a plurality of controllers to control corresponding ones of said mobile gaming units;
receiving video data at some of said mobile gaming units, said video data representing at least one of: (a) another one of said mobile gaming units, and (b) at least a portion of said gaming environment;
sending said video data from said some of said mobile gaming units to some of said controllers; and
receiving said video data at said some of said controllers and responsively displaying said video data.

25. The method of claim 24 further comprising
employing first and second mobile gaming units as said mobile gaming units;
employing first and second controllers as said controllers;
sending a first message from said first controller;
receiving said first message at said first mobile gaming unit and responsively outputting a wireless signal;
receiving said wireless signal at said second mobile gaming unit and responsively sending a second message, which confirms receipt of said wireless signal;
receiving said second message at said second controller and responsively sending a third message, which confirms receipt of said second message; and
receiving said third message at said first controller and responsively displaying a representation with said second mobile gaming unit.

26. The method of claim 25 further comprising
mimicking a weapon with said wireless signal; and
displaying a representation of an explosion from said weapon interacting with said second mobile gaming unit as said representation with said second mobile gaming unit.

27. The method of claim 25 further comprising
disabling said second mobile gaming unit responsive to receiving said second message at said second controller.

28. The method of claim 27 further comprising
sending a fourth message responsive said disabling said second mobile gaming unit; and
receiving said fourth message at said first controller and responsively displaying a fifth message.

29. The method of claim 28 further comprising
employing at least one of a game score, and a game over message as said fifth message.

30. The method of claim 25 further comprising
employing a plurality of sensors at said second mobile gaming unit to receive said wireless signal.

31. The method of claim 30 further comprising
employing first and second motors to move said second mobile gaming unit;
employing first and second sensors as said sensors; and
receiving said wireless signal at one of said first and second sensors and responsively disabling one of said first and second motors, respectively.

32. The method of claim 30 further comprising
receiving a first wireless signal as said wireless signal at said second mobile gaming unit;
employing a wireless output to output a second wireless signal from said second mobile gaming unit;
employing first and second motors to move said second mobile gaming unit;
employing first, second and third sensors as said sensors; and
receiving said first wireless signal at one of said first, second and third sensors and responsively disabling one of said wireless output, said first motor, and said second motor, respectively.

33. The method of claim 30 further comprising
employing first and second motors to move said second mobile gaming unit;
employing first, second and third sensors as said sensors; and
receiving said wireless signal at one of said first, second and third sensors and responsively disabling one of said first motor, said second motor, and both of said first and second motors, respectively.

34. The method of claim 24 further comprising
employing a surface with said gaming environment; and
employing one of rotating wheels and rotating treads to move said mobile gaming unit on said surface.

35. The method of claim 24 further comprising
employing a surface with said gaming environment; and
moving said mobile gaming unit above said surface.

36. The method of claim 24 further comprising
employing a liquid with said gaming environment; and
moving said mobile gaming unit through said liquid.

37. The method of claim 24 further comprising
employing a barrier for at least one of said mobile gaming units with said gaming environment; and
employing at least one of a device to mark a geographic line, a colored tape, and an infrared beam as said barrier.

38. The method of claim 24 further comprising
employing a barrier for at least one of said mobile gaming units with said gaming environment; and
employing a sensor at said at least one of said mobile gaming units to detect said barrier.

39. The method of claim 38 further comprising
selecting said sensor from the group comprising a radar sensor, a sonar sensor, an infrared proximity sensor, an image recognition sensor, a touch sensor, and a range finder sensor.

40. The method of claim 24 further comprising
employing a video camera to receive said video data at said one of said mobile gaming units;
employing a video display to display said video data; and
employing said video display to determine a position of said one of said mobile gaming units in said gaming environment.

41. The method of claim 40 further comprising
employing a barrier with said gaming environment; and
employing said video display to determine a position of said barrier in said gaming environment.

42. The method of claim 24 further comprising
employing first and second mobile gaming units as said mobile gaming units;
employing first and second controllers as said controllers;
communicating between said first mobile gaming unit and first controller;
communicating between said second mobile gaming unit and second controller;
communicating between said first and second mobile gaming units; and
communicating between said first and second controllers.

43. The method of claim 24 further comprising
providing computer-generated graphics at one of said controllers; and
displaying said video data in combination with said computer-generated graphics.

44. The method of claim 43 further comprising
selecting said computer-generated graphics from the group comprising a theme of a game, a status of a game, a status of one of said mobile gaming units, a representation of cross hairs for aiming a weapon at another one of said mobile gaming units, a representation of firing of a weapon at another one of said mobile gaming units, a representation of an explosion from firing of a weapon at another one of said mobile gaming units, and a representation of damage to one of said mobile gaming units.

45. The method of claim 43 further comprising
employing a representation of damage to one of said mobile gaming units as said computer-generated graphics.

46. The method of claim 45 further comprising
displaying a representation of a windshield of one of said mobile gaming units; and
displaying a representation of damage to said windshield.

47. The method of claim 24 further comprising
employing first and second mobile gaming units on a first team as some of said mobile gaming units; and
employing third and fourth mobile gaming units on a second team as some of said mobile gaming units.

48. The method of claim 47 further comprising
employing one of said controllers for each of said first, second, third and fourth mobile gaming units; and
disabling one of the mobile gaming units of said first team from one of said controllers for said second team and responsively displaying a corresponding message at the controllers for said second team.

49. The method of claim 47 further comprising
employing one of said controllers for each of said first, second, third and fourth mobile gaming units; and
disabling the first mobile gaming unit of said first team from the controller of the second mobile gaming unit of said first team and responsively displaying a corresponding message at the controller of the second mobile gaming unit.

50. The method of claim 24 further comprising
employing a sensor object as part of said gaming environment; and
sensing said sensor object with one of said mobile gaming units.

51. The method of claim 24 further comprising
employing at least one of a goal and a sensor object as part of said gaming environment; and
sensing said sensor object or one of said mobile gaming units with said goal.

52. The method of claim 24 further comprising
simulating armor on one of said mobile gaming units; and
limiting a maximum speed of said one of said mobile gaming units responsive to said step of simulating armor.

53. A gaming system for a gaming environment, said gaming system comprising:
a plurality of mobile gaming units; and
a plurality of controllers to control corresponding ones of said mobile gaming units,
with at least some of said mobile gaming units comprising:
means for receiving video data representing at least one of: (a) another one of said mobile gaming units, and (b) at least a portion of said gaming environment, and
means for sending said video data to a corresponding one of said controllers; and
with at least some of said controllers comprising:
means for receiving said video data from a corresponding one of said mobile gaming units, and
means for responsively displaying said received video data.

54. A gaming method for a gaming environment, said method comprising:
employing at least first and second mobile gaming units;
employing at least first and second controllers for said mobile gaming units;
sending a first message from the first controller;
receiving said first message at the first mobile gaming unit and responsively outputting a wireless signal;
receiving said wireless signal at the second mobile gaming unit and responsively sending a second message, which confirms receipt of said wireless signal;
receiving said second message at the second controller and responsively sending a third message, which confirms receipt of said second message; and
receiving said third message at the first controller and responsively displaying a representation with the second mobile gaming unit.

55. The method of claim 54 further comprising
receiving video data at the first mobile gaming unit;
sending said video data from the first mobile gaming unit to the first controller; and
receiving said video data at the first controller and responsively displaying said video data.

56. The method of claim 54 further comprising
employing unique serial numbers for each of said first and second mobile gaming units;
encoding the unique serial number of the first mobile gaming unit in said wireless signal at the first mobile gaming unit; and
decoding said unique serial number of the first mobile gaming unit from said wireless signal at the second mobile gaming unit, in order to identify said first mobile gaming unit.

57. The method of claim 54 further comprising
mimicking a weapon with said wireless signal.
